(19) United States
(12) Patent Application Publication
(10) Pub. No.: US 2026/0371168 A1
(43) Pub. Date: Nov. 19, 2026

(54) METHOD AND APPARATUS FOR INTER-GNB RESOURCE AGGREGATION

(71) Applicants: Centre of Excellence in Wireless Technology IITM, Chennai (IN); Indian Institute of Technology Madras (IIT Madras), Chennai (IN)

(72) Inventors: Dony Jos Muttath, Chennai (IN); Abhijeet Abhimanyu Masal, Chennai (IN); Jeniston Deviraj Klutto Milleth, Chennai (IN); Bhaskar Ramamurthi, Chennai (IN); Dhivagar Baskaran, Chennai (IN)

(21) Appl. No.: 19/676,432

(22) Filed: May 13, 2026

(30) Foreign Application Priority Data
May 14, 2025 (IN) 202541046569

(51) Int. Cl. H04W 28/088; H04W 56/00; H04W 74/0833

(52) U.S. Cl. CPC H04W 28/088; H04W 56/001; H04W 74/0833

(57) ABSTRACT

The present invention discloses a method, a user equipment (UE) (400), a first node (500) and a second node (600) for inter-gNB resource aggregation. The method includes receiving, by the UE (400), from a first node (500) serving the UE (400), a first Radio Resource Control (RRC) message comprising configuration information for at least one radio resources of a second node (600) and adding, by the UE (400), an additional radio resource. Further, the method includes transmitting, by the UE (400), a second RRC message corresponding to the additional radio resource and receiving, by the UE (400), a trigger signal, from the first node (500). Furthermore, the method includes performing, by the UE (400), one of activating and deactivating additional radio resource based on the trigger signal and performing, by UE (400), uplink synchronization for additional radio resource by initiating a random access procedure for the additional radio resource

### FIELD OF INVENTION

This application claims the benefit of and priority to Indian Provisional Patent Application No. 202541046569, filed on 14 May 2025, the entire disclosure of which is hereby incorporated by reference in its entirety. The present invention relates generally to wireless communication systems and, more particularly, to a method and system for handling inter-Next Generation Node B (gNB) resource aggregation (RA).

### BACKGROUND

In existing cellular systems, various mechanisms have been introduced to increase user data rates and improve overall network performance. Among these mechanisms are carrier aggregation (CA) and multiple transmit receive point (MTRP) schemes. Both CA and MTRP enable a single next generation Node B (gNB) to utilize multiple resource grids in frequency and/or space to serve a user equipment (UE). By doing so, the gNB can adapt to different deployment scenarios and support a wide range of use cases.

In CA-based deployments, higher frequency carriers typically provide larger available bandwidth and therefore greater capacity, but they are associated with more limited coverage due to higher path loss and propagation constraints. Conversely, lower frequency carriers generally offer wider coverage but with more limited capacity. By aggregating multiple downlink and uplink carriers, CA allows simultaneous service to multiple UEs, effectively increasing the total spectrum bandwidth available to the network and thereby enabling higher data rates for end users. However, the differing coverage characteristics of the aggregated carriers can introduce imbalances in how resources are utilized across frequencies and across UEs.

To address the limitations of individual carriers or single transmission points, MTRP schemes have been introduced. In such schemes, multiple TRPs may be deployed within a cell and coordinated to serve a UE that does not receive sufficient coverage or capacity from a single TRP. While this can improve performance at the cell edge or in coverage-challenged locations, it also introduces additional coordination, scheduling, and resource management complexity, particularly when multiple TRPs must be dynamically selected or configured for different UEs and services.

Modern cellular networks must simultaneously support a diverse mix of traffic types, including low bandwidth services such as voice and high bandwidth services such as video streaming and other data-intensive applications. This diversity leads to non-uniform traffic distribution within and across cells, as some areas or cells may experience significantly higher traffic loads than others. At the same time, UE transmit power limitations and the desire to achieve high data rates often result in smaller cell sizes being considered as a deployment option. While smaller cells can help meet link budget requirements and improve spectral reuse, they can also exacerbate traffic non-uniformity by creating clusters of heavily loaded cells alongside lightly loaded cells.

The combination of heterogeneous traffic demands, varying carrier characteristics, and UE power constraints can therefore result in situations where certain cells or carriers are congested while others are underutilized. In such environments, it may be desirable to augment the serving cell with additional transmission capabilities. In this context, a “resource” may refer, for example, to a TRP, a carrier, or a frequency band that effectively extends the network infrastructure available to serve a given UE. These resources may be provided by a neighbouring gNB (e.g., a second gNB, gNB2) or may be located in different bands within the same gNB or across different gNBs.

When additional resources are made available from neighbouring gNBs or across multiple bands, further challenges arise. These include, for example, coordinating resources between different network nodes, managing interference between overlapping coverage areas, handling differences in backhaul capacity or latency, and ensuring that UEs can reliably access and utilize the additional resources without degrading ongoing services. Moreover, the dynamic nature of traffic patterns and user mobility can make it difficult to determine when and how to supplement a serving cell with such additional resources in a way that consistently improves coverage, capacity, and throughput.

Accordingly, there is a need to address the above-described disadvantages and shortcomings, or at least to provide a useful alternative.

### OBJECT OF THE INVENTION

The principal object of the invention herein is to provide a method and system for handling inter-gNB resource aggregation.

Another object of the invention herein is to provide a method for allowing surplus resources from low-traffic gNBs to be allocated to the UEs in high-traffic demands, effectively balancing spatially non-uniform traffic distributions, resulting in improved cell-edge spectral efficiency or overall network throughput.

Yet another object of the invention herein is to provide a method for resource aggregation which is also beneficial at the cell edge where it helps to maintain better throughput and coverage.

### SUMMARY

In an aspect, the present invention provides a method performed by a user equipment (UE) for inter-gNB resource aggregation. The method includes receiving by the UE from a first node serving the UE a first Radio Resource Control (RRC) message comprising configuration information for at least one radio resource of a second node, where the at least one radio resource comprises at least one of at least one carrier, at least one band, and at least one transmission reception point, and adding by the UE an additional radio resource, where the additional radio resource is one of the at least one radio resource in full and the at least one radio resource in part, where the at least one radio resource in part is obtained based on an execution condition. Further, the method includes transmitting by the UE a second RRC message corresponding to the additional radio resource and receiving by the UE a trigger signal from the first node. Furthermore, the method includes performing by the UE one of activating and deactivating the additional radio resource based on the trigger signal and performing by the UE an uplink synchronization for the additional radio resource by initiating a random access procedure for the additional radio resource.

In another aspect, the present invention provides a method performed by a first node for inter-gNB resource aggregation to serve the UE. The method includes transmitting by a first node a Resource Addition Request message to a second node requesting configuration information for at least one radio resource, receiving by the first node a Resource Addition Request Acknowledge message from the second node including the configuration information for the at least one radio resource, and assigning by the first node a resource index to the at least one radio resource. Further, the method includes transmitting by the first node a first RRC message including the configuration information and a resource index of the at least one radio resource to the UE, receiving by the first node a second RRC message corresponding to an additional radio resource from the UE, and transmitting by the first node a message to the second node indicating one of addition and release of the at least one radio resource. Furthermore, the method includes determining by the first node the addition of at least one radio resource, coordinating by the first node with the second node for activation and deactivation of an additional radio resource, transmitting by the first node a trigger signal for activating or deactivating the additional radio resource to the UE, and coordinating by the first node with the UE for an uplink synchronization of the additional radio resource.

In another aspect, the present invention provides a method performed by a second node for inter-gNB resource aggregation to serve the UE. The method includes receiving by a second node a Resource Addition Request message from a first node requesting configuration of at least one radio resource of the second node, transmitting by the second node a Resource Addition Request Acknowledge message comprising the configuration information for at least one radio resource to the first node, and receiving by the second node a message from the first node indicating one of addition and release of the at least one radio resource. Further, the method includes coordinating by the second node with the first node for one of activating and deactivating an additional radio resource and coordinating by the second node with the UE for an uplink synchronization of the additional radio resource.

In yet another aspect, the present invention provides a UE for inter-gNB resource aggregation. The UE includes a processor, a memory, and a Cross-gNB Resource Aggregation Controller connected to the processor and the memory. The Cross-gNB Resource Aggregation Controller receives from a first node serving the UE a first Radio Resource Control (RRC) message comprising configuration information for at least one radio resource of a second node, wherein the at least one radio resource comprises at least one of at least one carrier, at least one band, and at least one transmission reception point, and adds an additional radio resource, wherein the additional radio resource is one of the at least one radio resource in full and the at least one radio resource in part, wherein the at least one radio resource in part is obtained based on an execution condition. Further, the Cross-gNB Resource Aggregation Controller transmits a second RRC message corresponding to the additional radio resource and receives a trigger signal from the first node. Furthermore, the Cross-gNB Resource Aggregation Controller performs one of activating and deactivating the additional radio resource based on the trigger signal and performs an uplink synchronization for the additional radio resource by initiating a random access procedure for the additional radio resource.

In yet another aspect, the present invention provides a first node for inter-gNB resource aggregation. The first node includes a processor, a memory, and a Cross-gNB Resource Orchestration Controller connected to the processor and the memory. The Cross-gNB Resource Orchestration Controller transmits a Resource Addition Request message to a second node requesting configuration information for at least one radio resource, receives a Resource Addition Request Acknowledge message from the second node including the configuration information for the at least one radio resource, and assigns a resource index to the at least one radio resource. Further, the Cross-gNB Resource Orchestration Controller transmits a first RRC message including the configuration information and a resource index of the at least one radio resource to the UE, receives a second RRC message corresponding to an additional radio resource from the UE, and transmits a message to the second node indicating one of addition and release of the at least one radio resource. Furthermore, the Cross-gNB Resource Orchestration Controller determines the addition of at least one radio resource, coordinates with the second node for activation and deactivation of an additional radio resource, transmits a trigger signal for activating or deactivating the additional radio resource to the UE, and coordinates with the UE for an uplink synchronization of the additional radio resource.

In yet another aspect, the present invention provides a second node for inter-gNB resource aggregation. The second node includes a processor, a memory, and a Cross-gNB Resource Provisioning Controller connected to the processor and the memory. The Cross-gNB Resource Provisioning Controller receives a Resource Addition Request message from a first node requesting configuration of at least one radio resource of the second node, transmits a Resource Addition Request Acknowledge message comprising the configuration information for at least one radio resource to the first node, and receives a message from the first node indicating one of addition and release of the at least one radio resource. Further, the Cross-gNB Resource Provisioning Controller coordinates with the first node for one of activating and deactivating an additional radio resource and coordinates with the UE for an uplink synchronization of the additional radio resource.

These and other aspects of the embodiments will be better understood with the following description and accompanying drawings. The descriptions, indicating preferred embodiments and specific details, are for illustration and not limitation. Many changes and modifications may be made within the scope of the embodiments, which include all such modifications.

### BRIEF DESCRIPTION OF FIGURES

The present invention is illustrated in the accompanying drawings, where like reference letters indicate corresponding parts across various figures. The embodiments herein will be better understood from the following description and the accompanying drawings.

FIG. 1 is a schematic diagram illustrating load balancing using inter-gNB co-ordination according to prior art.

FIG. 2 is a schematic diagram illustrating inter-gNB co-ordination for Fixed Wireless Access (FWA) device with heavy load according to prior art.

FIG. 3 is a schematic diagram illustrating inter-gNB co-ordination when FR3/FR2 bands are deployed as separate gNB according to prior art.

FIG. 4 illustrates hardware components associated with the UE according to an embodiment of the present disclosure.

FIG. 5 illustrates hardware components associated with the first node according to an embodiment of the present disclosure.

FIG. 6 illustrates hardware components associated with the second node according to an embodiment of the present disclosure.

FIG. 7 is a flow diagram that illustrates a proposed method for inter-gNB resource aggregation by the UE according to the embodiments disclosed herein.

FIG. 8 is a flow diagram that illustrates a proposed method for inter-gNB resource aggregation to serve the UE by the first node according to the embodiments disclosed herein.

FIG. 9 is a flow diagram that illustrates a proposed method for inter-gNB resource aggregation to serve the UE by the second node according to the embodiments disclosed herein.

FIG. 10 is a sequence diagram that illustrates the signalling procedure for method P11 according to embodiments as disclosed herein.

FIG. 11 is a sequence diagram that illustrates a signalling procedure for method P12 according to embodiments disclosed herein.

FIG. 12 is a schematic diagram that illustrates the proposed resource mapping for inter-gNB coordination according to embodiments as disclosed herein.

FIG. 13a is a sequence diagram that illustrates the time alignment method P31 with RRC based activation according to embodiments as disclosed herein.

FIG. 13b is a sequence diagram that illustrates the time alignment method P31 with MAC CE based activation according to embodiments as disclosed herein.

FIG. 14 is a sequence diagram that illustrates a time alignment method P32 with MAC CE-based activation according to embodiments disclosed herein.

FIG. 15 is a sequence diagram that illustrates a time alignment method P33 with MAC CE based activation according to embodiments as disclosed herein.

FIG. 16 is a sequence diagram that illustrates a time alignment method P34 with MAC CE-based activation according to embodiments as disclosed herein.

FIG. 17 is a sequence diagram that illustrates the time alignment method P35 with RRC-based activation according to embodiments as disclosed herein.

FIG. 18 is a sequence diagram that illustrates a time alignment method P36 with RRC-based activation according to embodiments as disclosed herein.

### DETAILED DESCRIPTION OF INVENTION

The embodiments and their features are detailed with reference to the non-limiting examples shown in the drawings and described below. Well-known components and techniques are omitted to avoid unnecessary detail. The described embodiments are not mutually exclusive and can be combined to form new embodiments. The term "or" is used in a non-exclusive sense unless stated otherwise. The examples provided are for illustrative purposes to aid understanding and should not be seen as limiting the scope of the embodiments.

As is existing in the field, embodiments can be described and illustrated in terms of blocks which carry out a described function or functions. These blocks, which can be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits may, for example, be embodied in one or more semiconductor chips, or on substrate supports such as printed circuit boards and the like. The circuits constituting a block can be implemented by dedicated hardware, or by a processor (e.g., one or more programmed microprocessors and associated circuitry), or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure.

The drawings help illustrate the technical features but do not limit the embodiments. The disclosure includes any modifications, equivalents, and substitutes beyond those shown. Terms like first, second, etc., are used for distinction and do not limit the elements.

Throughout the specification, the terms gNB1, serving gNB, and first node are used interchangeably, and throughout the specification, the terms gNB2, neighbouring gNB, and second node are used interchangeably. The ability to aggregate a resource from a neighbouring gNB as an additional cell, band, or TRP plays a crucial role in optimizing network performance. In particular, the following are some scenarios where such an approach enhances throughput and coverage.

Use cases for aggregating the carrier from another gNB are disclosed below.

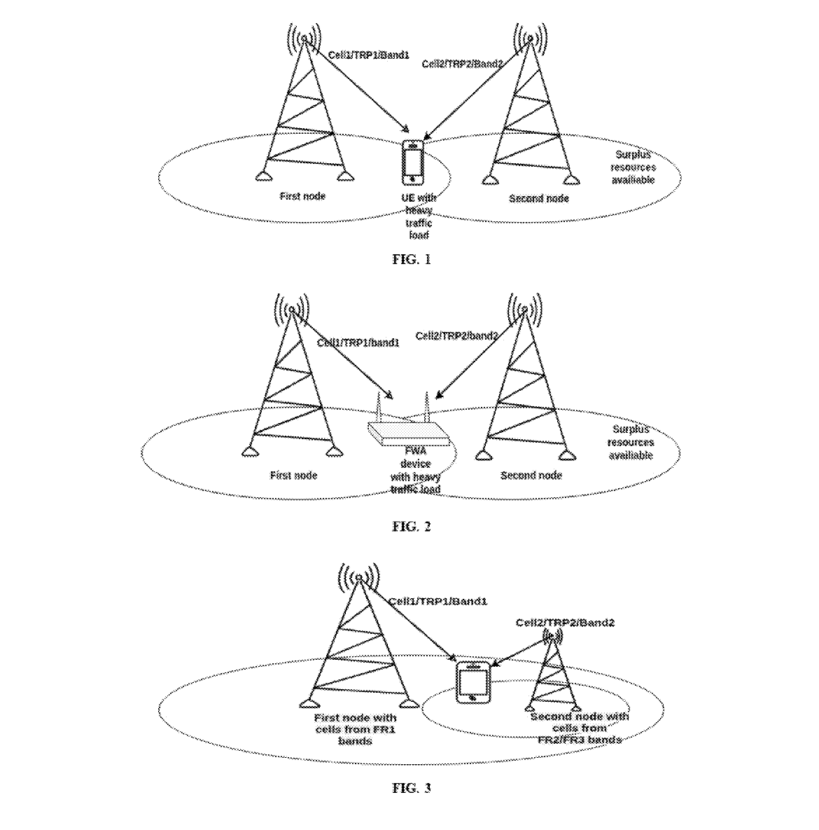

Referring now to the drawings, and more particularly to FIGS. 1 through 18, there are shown preferred embodiments.

FIG. 1 is a schematic diagram illustrating load balancing using inter-gNB co-ordination according to the prior art. In dynamic network environments, the number of UEs in a cell and further the traffic demand varies across different UEs, leading to non-uniform resource utilization across neighbouring gNBs. While some cells experience heavy traffic loads, others remain underutilized. In such cases, surplus resources from a lightly loaded gNB can be allocated to UEs in neighbouring heavy-traffic sites, as depicted in FIG. 1.

FIG. 2 is a schematic diagram illustrating inter-gNB co-ordination for a Fixed Wireless Access (FWA) device with heavy load according to the prior art. The FWA is a key solution for providing broadband services in areas where fiber deployment is either costly or not viable. The FWA heavily relies on dedicated carriers from a gNB to serve FWA devices. As the number of FWA users increases in a particular cell, or the data rate requirement increases for the user, or both, the available capacity on these dedicated carriers may become exhausted, leading to network congestion and service degradation. In such scenarios, as depicted in FIG. 2, when a neighbouring gNB has underutilized carriers, it can contribute additional resources to an overloaded FWA gNB, ensuring load balancing. This contribution helps to avoid performance degradation, particularly during peak usage hours when broadband demand is high in a particular cell. For example, in suburban or rural areas where multiple households rely on the FWA for internet access, a particular gNB might struggle to handle the increasing number of users or data consumption or both. By utilizing additional resources from a neighbouring gNB, FWA services can maintain consistent speeds, lower latency, and better overall reliability even as demand fluctuates.

FIG. 3 is a schematic diagram illustrating inter-gNB co-ordination when FR3/FR2 bands are deployed as a separate gNB according to the prior art. In certain network deployments, frequency bands are assigned to different gNBs based on their specific deployment strategies. Some operators may opt to deploy FR3/FR2 bands under a separate gNB rather than co-locating them with FR1 band carriers at the same gNB. This scenario is depicted in FIG. 3.

FR1 bands (sub-6 GHz) are typically deployed on a gNB designed to provide wide-area coverage, ensuring better signal propagation and connectivity over long distances. FR3/FR2 bands (mmWave) are assigned to a separate gNB optimized for high-capacity services in urban areas where greater bandwidth is required. Under current specifications, CA-capable UEs can aggregate carriers within the same gNB, but they cannot combine the carriers of different gNBs. However, DC-capable UEs can use NR-DC to aggregate FR1 and FR3/FR2 bands used by different gNBs, allowing for better spectrum utilization, higher data rates, and an enhanced user experience. By utilizing dual connectivity, networks can efficiently balance coverage and capacity, ensuring seamless connectivity for UEs across diverse deployment environments.

UEs located at the edge of a cell often experience degraded signal quality due to the increased pathloss proportional to the distance from the serving gNB. This results in lower throughput or increased latency and potential connection drops as well. The issue is furthermore aggravated when the serving gNB operates on high-frequency bands (e.g., FR3/FR2), which have more limited coverage than FR1 bands. To extend coverage and improve throughput, a neighbouring gNB can provide an additional connection to these cell-edge UEs to provide better mobility experiences and more coverage. By aggregating a carrier from a neighbouring gNB, reliability increases for the cell-edge UEs by adding a secondary path and thus ensuring consistent network performance at the cell edge. The coverage and throughput of cell-edge users can be extended by having another connection from the neighbouring gNB.

Currently, carrier aggregation and MTRP features are restricted to carriers or cells within a single gNB managed under a single CellGroupConfig as SpCell and SCells. In contrast, dual connectivity (DC) operates across two distinct gNBs, a master node (MN) and a secondary node (SN), each maintaining separate CellGroupConfigs (MCG and SCG). Since the DC requires the UE to handle independent CellGroupConfigs, it introduces additional complexity by requiring the management of two parallel protocol stacks.

To enable inter-gNB RA without taxing the UE with multiple stacks, modifications to the existing aggregation framework for CA and MTRP are necessary. Unlike dual connectivity, where data aggregation occurs at the RAN level, the proposed inter-gNB co-ordination scheme performs aggregation at the core network level by duplicating and/or splitting data at the core instead of the RAN. This approach simplifies coordination between gNBs and eliminates the need for data transmission over the Xn interface. Aggregating the resources from adjacent gNBs under a single cell or a single cell group requires modifications to existing specification procedures in NR. This proposal introduces necessary modifications to SCell addition, SCell activation, and timing alignment procedures, ensuring seamless inter-gNB RA while enhancing network efficiency.

In NR-DC, a UE connects to two NR gNBs, one acting as a Master Node (MN) and another as a Secondary Node (SN), which communicate via a backhaul link. The MN manages control plane connectivity and provides initial system configurations through RRC signalling, while the SN is added through the SN addition procedure. Scheduling decisions are handled independently by each node. The main challenge in the NR-DC is the need for extensive network coordination, making connectivity non-transparent to the UE. The UE must maintain two active protocol stacks to receive carriers from different gNBs, adding complexity.

To address this, new methods for inter-gNB RA are proposed to create a less complex scheme for the UE. These proposed methods outline the necessary procedures, including resource addition, resource activation, and time alignment, to enable inter-gNB co-ordination while ensuring a more seamless and efficient operation than dual connectivity. This is derived from the existing 5G NR Carrier Aggregation procedures and involves three key steps.

Procedure 1, SCell Addition, is handled by the RRC entity at the serving gNB, where the SCell is configured and associated with a specific carrier through SCell index mapping. The gNB always initiates the process of SCell addition. To initiate the SCell addition for a UE, the gNB can either use a blind addition method or a method based on the measurement report that the UE sends to the gNB. The blind addition procedure is implemented without the need for UE measurements when the SCell coverage footprint aligns with that of the PCell. In such cases, the base station does not require a measurement report to initiate SCell addition. The SCell addition procedure is performed by the RRC entity at the gNB on the first cell in a cell group that the UE connects to, which is known as SpCell (as per the 5G specifications). The process is initiated by the gNB by communicating the RRC Reconfiguration message containing the list of SCells to add to the UE using the sCellToAddModList. This list contains the SCell Configuration (sCellConfig), which the UE must apply to add the SCell into its connection. The information is transmitted to the UE through an RRC Reconfiguration message on the PCell.

The SCell Configuration defines the parameters required for adding an SCell. It typically includes sCellConfigCommon (common cell-specific configuration parameters shared across UEs), sCellConfigDedicated (UE-specific parameters), and sCellIndex (which identifies the SCell being added). Additionally, it can include SMTC (SSB periodicity/offset/duration for SCell addition), sCellState (indicating whether the SCell should be considered activated upon configuration), and some other optional details. Once the UE receives the sCellToAddModList from the gNB, it processes each sCellIndex in the list. For every sCellIndex, the corresponding SCell is added based on the sCellConfigCommon and sCellConfigDedicated provided.

Procedure 2, SCell Activation/Deactivation for downlink synchronization, is managed by one MAC entity in the gNB, which schedules and signals the activation or deactivation of SCells via MAC CE, enabling the UE to achieve downlink synchronization with the configured carrier. SCell activation in Carrier Aggregation can be triggered through several mechanisms, including reception of a standard or enhanced SCell Activation/Deactivation MAC Control Element (MAC CE), or by configuration when the parameter sCellState is present. When the UE receives a MAC CE indicating activation, it synchronizes with the SCell via the first SSB, starts necessary timers like the sCellDeactivationTimer, and begins operation on the SCell, such as PDCCH monitoring and CSI reporting. The MAC CE can be either one octet in size (used when up to 7 SCells are configured) or four octets (for up to 31 SCells), where each bit (Ci) corresponds to the activation status of a specific SCell indexed by SCellIndex; a bit value of 1 indicates activation and 0 indicates deactivation.

SCell deactivation, on the other hand, can be triggered by a deactivation command in the MAC CE or by expiry of the associated sCellDeactivationTimer. Upon deactivation, the UE stops all activity on that SCell, stops related timers, suspends or clears uplink grants, releases HARQ buffers, and deactivates the corresponding bandwidth parts (BWPs). This dynamic activation and deactivation of SCells ensure efficient use of radio resources while maintaining flexibility and responsiveness in the UE connectivity.

Activation/deactivation of a configured SCell can be triggered through multiple mechanisms. In Layer 2 Signalling (Standard MAC CE), the gNB sends an SCell Activation/Deactivation MAC CE to the UE. Upon receiving this message, the UE interprets the bit fields (C-fields) in the MAC CE to determine which SCells should be activated. If a particular bit corresponding to an SCellIndex is set to 1, that SCell is activated; if it is set to 0, it is deactivated. In Layer 2 Signalling (Enhanced MAC CE), this enhanced version of the MAC CE includes TRS (Tracking Reference Signal) identifiers, which enable faster and fine-tuning synchronization with the SCell. TRS helps the UE align more efficiently to the timing and frequency of the newly activated SCell. In Layer 3 Signalling (RRC Configuration), during SCell addition, if the parameter sCellState is explicitly set to "activated", the UE treats the SCell as active immediately upon configuration without requiring any MAC CE-based signalling. This is typically used for persistently required SCells. In Timer-Based Deactivation, the sCellDeactivationTimer is configured for each SCell. If this timer expires, indicating that no data has been scheduled or activity observed for the configured time duration, the UE automatically deactivates the SCell. When an SCell is deactivated, the UE stops monitoring PDCCH and halts all data activity on that SCell.

Procedure 3, Uplink Synchronization (Time Alignment) with a non-co-located SCell, involves the use of a PDCCH order and contention-free random access (CFRA) on the SCell for uplink synchronization, followed by a random access response (RAR) on the PCell. If the SCell is non-co-located with the PCell and it is assigned to a new secondary timing advance group (STAG), this assignment requires a separate timing alignment. To achieve this, the gNB initiates a PDCCH order on the activated SCell using contention-free random access (CFRA). In CFRA, the network assigns a dedicated preamble for Msg1 transmission, and once the UE receives the random access response (RAR) from the network with the timing advance values, it completes the random access procedure.

The main steps involved in this process are as follows. In PDCCH Order Initiation, the gNB sends a PDCCH order on the SCell that the UE needs to time align, instructing the UE to perform random access using a dedicated preamble. The CFRA procedure depends on the gNB providing the UE with PRACH preamble resources. These resources can be indicated within DCI Format 1_0 on the PDCCH when initiating a PDCCH order. The gNB initiates the PDCCH order on the activated SCell to initiate the RA in the UE with the dedicated preamble index along with a corresponding SS/PBCH block index. This information is transmitted in DCI Format 1_0 with the PDCCH CRC scrambled by the assigned C-RNTI of the UE. In the step where the UE transmits the dedicated preamble, upon receiving the PDCCH order, the UE sends the dedicated preamble to the activated SCell as part of the random access procedure. In the Random Access Response (RAR) step, the gNB transmits the RAR message via the PCell, providing the UE with uplink resources and a timing advance command for synchronization. The command is addressed to the UE’s RAPID (Random Access Preamble Identifier).

Each of these steps associated with a single gNB needs to be enhanced for inter-gNB scenarios and requires enhancements to improve responsiveness and reduce the UE complexity.

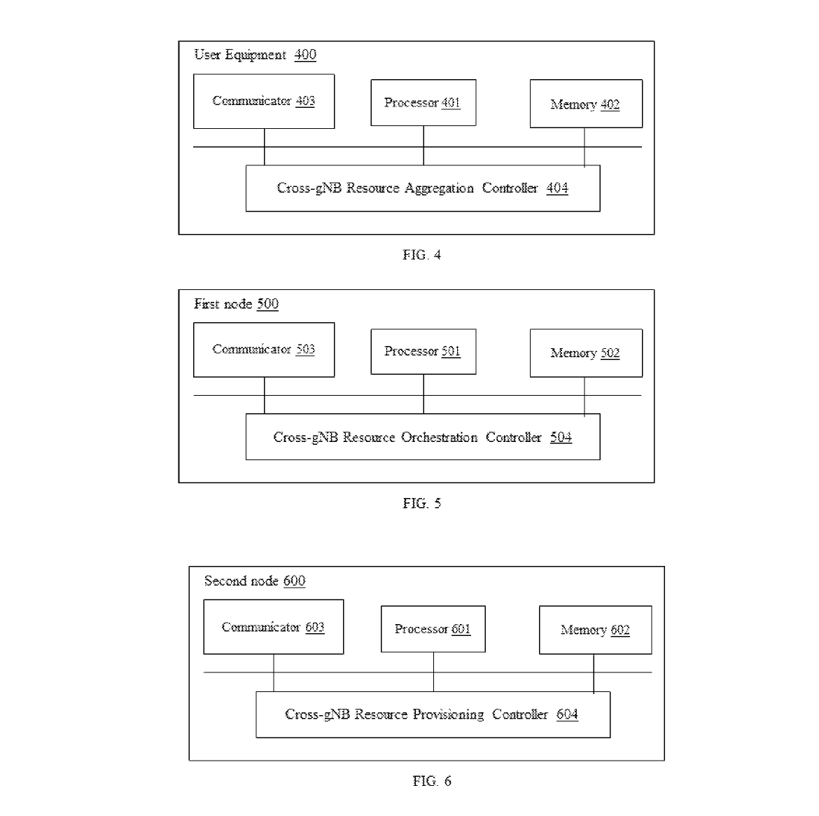

FIG. 4 illustrates hardware components associated with the UE (400) according to an embodiment of the present disclosure. In an embodiment, examples of the UE (400) include, but are not limited to, a 5G-capable mobile phone, a smartphone, a tablet, a wearable device, an Internet of Things (IoT) device, an industrial wireless device, a connected vehicle, a vehicle-to-everything communication device, a customer premises equipment device, a wireless modem, an extended reality device, or any other wireless communication device capable of communicating with one or more gNBs.

As illustrated in FIG. 4, the UE (400) includes a processor (401), a memory (402), a communicator (403), and a Cross-gNB Resource Aggregation Controller (404). The processor (401) is configured to execute instructions stored in the memory (402) and to perform operations associated with inter-gNB resource aggregation. The processor (401) is communicatively coupled to the memory (402), the communicator (403), and the Cross-gNB Resource Aggregation Controller (404). In an embodiment, the processor (401) includes one or more application processors, baseband processors, digital signal processors, microcontrollers, processing cores, hardware accelerators, or any combination thereof.

The memory (402) is configured to store instructions executable by the processor (401), data used by the processor (401), configuration information associated with a first radio resource, configuration information associated with an additional radio resource, information associated with a first RRC message, and information associated with a second RRC message used for performing operations described herein. In an embodiment, the memory (402) comprises one or more non-transitory computer-readable storage media, including volatile memory, non-volatile memory, or a combination thereof. In an embodiment, the memory (402) stores information associated with the first RRC message received from the first node (500), information associated with a trigger signal received from the first node (500), and state information associated with activation or deactivation of the additional radio resource.

The communicator (403) is configured to facilitate communication between the UE (400), the first node (500), and the second node (600). The communicator (403) may support one or more cellular communication interfaces, radio frequency circuits, antenna modules, transceiver circuits, baseband circuits, or any combination thereof. In an embodiment, the communicator (403) is configured to receive the first RRC message from the first node (500) serving the UE (400), transmit the second RRC message corresponding to the additional radio resource, receive the trigger signal from the first node (500), and communicate using the additional radio resource based on activation or deactivation of the additional radio resource.

The Cross-gNB Resource Aggregation Controller (404) may be implemented using processing circuitry, dedicated logic circuitry, programmable logic, firmware, one or more processors executing instructions, or any combination thereof. The Cross-gNB Resource Aggregation Controller (404) is operatively coupled to the processor (401), the memory (402), and the communicator (403). The hardware implementation of the Cross-gNB Resource Aggregation Controller (404) enables efficient and reliable execution of processes associated with inter-gNB resource aggregation. The Cross-gNB Resource Aggregation Controller (404) is configured to receive or process the first RRC message, determine or add an additional radio resource associated with the second node (600), generate or cause transmission of the second RRC message corresponding to the additional radio resource, receive or process the trigger signal, perform activation or deactivation of the additional radio resource based on the trigger signal, maintain state information associated with the additional radio resource, and perform uplink synchronization for communication using the additional radio resource.

In an embodiment, the Cross-gNB Resource Aggregation Controller (404) includes or is associated with control-state registers, buffer memories, timing circuits, synchronization circuits, radio resource control processing circuits, baseband processing circuits, transceiver control circuits, or dedicated logic circuits configured to support hardware-level execution of RRC message processing, additional radio resource configuration, trigger-signal processing, activation or deactivation control, timing alignment, buffer management, uplink synchronization, and inter-gNB resource aggregation procedures.

In an embodiment, the Cross-gNB Resource Aggregation Controller (404), in cooperation with the processor (401), the memory (402), and the communicator (403), controls one or more hardware resources of the UE (400) to execute inter-gNB resource aggregation. The one or more hardware resources include at least one radio transceiver, antenna module, baseband processor, timing circuit, buffer memory, and control-state register. The Cross-gNB Resource Aggregation Controller (404) configures the one or more hardware resources based on the first RRC message, the second RRC message, and the trigger signal, such that the UE (400) performs activation or deactivation of the additional radio resource and performs uplink synchronization for communication associated with the additional radio resource.

In an embodiment, the Cross-gNB Resource Aggregation Controller (404) includes or is associated with one or more processing cores, accelerator circuits, control-state registers, buffer memories, comparator circuits, timing circuits, interface buses, memory controllers, or dedicated logic circuits configured to support hardware-level execution of structured orchestration package generation and validation and execution mode selection.

In operation, the Cross-gNB Resource Aggregation Controller (404) receives, from the first node (500) serving the UE (400), the first RRC message comprising configuration information for at least one radio resource of the second node (600), where the at least one radio resource comprises at least one of at least one carrier, at least one band, and at least one transmission reception point. Further, the Cross-gNB Resource Aggregation Controller (404) adds the additional radio resource, where the additional radio resource is one of the at least one radio resource in full and the at least one radio resource in part, where the at least one radio resource in part is obtained based on an execution condition.

Furthermore, the Cross-gNB Resource Aggregation Controller (404) transmits the second RRC message corresponding to the additional radio resource and receives the trigger signal from the first node (500). Moreover, the Cross-gNB Resource Aggregation Controller (404) performs one of activating and deactivating the additional radio resource based on the trigger signal and performs an uplink synchronization for the additional radio resource by initiating a random access procedure for the additional radio resource.

FIG. 5 illustrates hardware components associated with the first node (500) according to an embodiment of the present disclosure. In an embodiment, the first node (500) may include a gNB, a serving gNB, a base station, a next generation radio access network node, a centralized unit (CU), a distributed unit (DU), or a radio access network node capable of communicating with the UE (400) and the second node (600) for inter-gNB resource aggregation.

As illustrated in FIG. 5, the first node (500) includes a processor (501), a memory (502), a communicator (503), and a Cross-gNB Resource Orchestration Controller (504). The processor (501) executes instructions stored in the memory (502) and performs operations described herein, including operations associated with inter-gNB resource aggregation. The processor (501) is communicatively coupled to the memory (502), the communicator (503), and the Cross-gNB Resource Orchestration Controller (504). In an embodiment, the processor (501) includes one or more baseband processors, digital signal processors, application processors, processing cores, hardware accelerators, or any combination thereof.

The memory (502) stores instructions executable by the processor (501), data used by the processor (501), information associated with a Resource Addition Request message, information associated with a Resource Addition Request Acknowledge message, resource index information, radio resource configuration information, and state information associated with activation or deactivation of at least one additional radio resource. In an embodiment, the memory (502) comprises one or more non-transitory computer-readable storage media including volatile memory, non-volatile memory, or a combination thereof. In an embodiment, the memory (502) stores information associated with the Resource Addition Request Acknowledge message received from the second node (600).

The communicator (503) facilitates communication between the UE (400), the first node (500), and the second node (600). The communicator (503) may support one or more cellular communication interfaces, radio frequency circuits, antenna modules, transceiver circuits, baseband circuits, fronthaul interfaces, midhaul interfaces, backhaul interfaces, or inter-node communication interfaces. In an embodiment, the communicator (503) receives the Resource Addition Request Acknowledge message from the second node (600), wherein the Resource Addition Request Acknowledge message includes configuration information for the at least one radio resource. The communicator (503) also exchanges signalling with the UE (400) and the second node (600) for adding, activating, deactivating, and synchronizing the additional radio resource.

The Cross-gNB Resource Orchestration Controller (504) may be implemented using hardware, firmware, software, processing circuitry, dedicated logic circuitry, programmable logic, one or more processors executing instructions, or any combination thereof. The Cross-gNB Resource Orchestration Controller (504) is operatively coupled to the processor (501), the memory (502), and the communicator (503). The hardware implementation of the Cross-gNB Resource Orchestration Controller (504) enables efficient and reliable execution of processes associated with inter-gNB resource aggregation. The Cross-gNB Resource Orchestration Controller (504) transmits a Resource Addition Request message, receives a Resource Addition Request Acknowledge message, assigns a resource index, receives a second RRC message, transmits a message to the second node, determines the addition, coordinates with the second node for activation and deactivation, transmits a trigger signal, and coordinates with the UE for uplink synchronization.

In an embodiment, the Cross-gNB Resource Orchestration Controller (504) includes or is associated with control-state registers, buffer memories, timing circuits, synchronization circuits, radio resource control processing circuits, baseband processing circuits, inter-node interface circuits, transceiver control circuits, or dedicated logic circuits for supporting hardware-level execution of Resource Addition Request processing, Resource Addition Request Acknowledge processing, resource index assignment, second RRC message processing, additional radio resource addition, trigger-signal transmission, activation or deactivation coordination, timing alignment, buffer management, uplink synchronization, and inter-gNB resource aggregation procedures.

In an embodiment, the Cross-gNB Resource Orchestration Controller (504), in cooperation with the processor (501), the memory (502), and the communicator (503), controls one or more hardware resources of the first node (500) to execute inter-gNB resource aggregation. The one or more hardware resources include at least one baseband processor, radio transceiver, antenna module, timing circuit, synchronization circuit, buffer memory, control-state register, and inter-node communication interface. The Cross-gNB Resource Orchestration Controller (504) controls the one or more hardware resources based on the Resource Addition Request message, the Resource Addition Request Acknowledge message, the second RRC message, and the trigger signal, such that the first node (500) adds the additional radio resource, coordinates activation or deactivation of the additional radio resource with the second node (600), and coordinates uplink synchronization with the UE (400).

In an embodiment, the Cross-gNB Resource Orchestration Controller (504) includes, or is associated with, one or more processing cores, accelerator circuits, control-state registers, buffer memories, comparator circuits, timing circuits, interface buses, memory controllers, or dedicated logic circuits configured to support hardware-level execution of structured orchestration package generation and validation, and execution mode selection.

In operation, the Cross-gNB Resource Orchestration Controller (504) transmits a Resource Addition Request message to a second node (600) requesting configuration information for at least one radio resource, and receives a Resource Addition Request Acknowledge message from the second node (600) including the configuration information for the at least one radio resource. The Cross-gNB Resource Orchestration Controller (504) further assigns a resource index to the at least one radio resource, transmits a first RRC message including the configuration information and a resource index of the at least one radio resource to the UE (400), and receives a second RRC message corresponding to an additional radio resource from the UE (400).

In a further aspect, the Cross-gNB Resource Orchestration Controller (504) transmits a message to the second node (600) indicating one of addition and release of the at least one radio resource, determines the addition of at least one radio resource, and coordinates with the second node (600) for activation and deactivation of an additional radio resource. Furthermore, the Cross-gNB Resource Orchestration Controller (504) transmits a trigger signal for activating or deactivating the additional radio resource to the UE (400), and coordinates with the UE (400) for an uplink synchronization of the additional radio resource.

FIG. 6 illustrates hardware components associated with the second node (600) according to an embodiment of the present disclosure. In an embodiment, the second node (600) may include a gNB, an assisting gNB, a target gNB, a secondary gNB, a base station, a next generation radio access network node, a centralized unit (CU), a distributed unit (DU), or a radio access network node capable of communicating with the first node (500) and the UE (400) for inter-gNB resource aggregation.

As illustrated in FIG. 6, the second node (600) includes a processor (601), a memory (602), a communicator (603), and a Cross-gNB Resource Provisioning Controller (604). The processor (601) executes instructions stored in the memory (602) and performs operations described herein, including operations associated with inter-gNB resource aggregation. The processor (601) is communicatively coupled to the memory (602), the communicator (603), and the Cross-gNB Resource Provisioning Controller (604). In an embodiment, the processor (601) includes one or more baseband processors, digital signal processors, application processors, processing cores, hardware accelerators, or any combination thereof.

The memory (602) stores instructions executable by the processor (601), data used by the processor (601), information associated with a Resource Addition Request message, information associated with a Resource Addition Request Acknowledge message, configuration information of at least one radio resource of the second node (600), additional radio resource state information, activation or deactivation information, and uplink synchronization information used for performing operations described herein. In an embodiment, the memory (602) comprises one or more non-transitory computer-readable storage media including volatile memory, non-volatile memory, or a combination thereof. In an embodiment, the memory (602) stores information associated with the Resource Addition Request message received from the first node (500).

The communicator (603) facilitates communication between the UE (400), the first node (500), and the second node (600). The communicator (603) may support one or more cellular communication interfaces, radio frequency circuits, antenna modules, transceiver circuits, baseband circuits, fronthaul interfaces, midhaul interfaces, backhaul interfaces, or inter-node communication interfaces. In an embodiment, the communicator (603) receives the Resource Addition Request message from the first node (500), wherein the Resource Addition Request message requests configuration of at least one radio resource of the second node (600). The communicator (603) further transmits a Resource Addition Request Acknowledge message to the first node (500), receives a message from the first node (500), and exchanges signalling with the UE (400) for activation or deactivation and uplink synchronization of the additional radio resource.

The Cross-gNB Resource Provisioning Controller (604) may be implemented using hardware, firmware, software, processing circuitry, dedicated logic circuitry, programmable logic, one or more processors executing instructions, or any combination thereof. The Cross-gNB Resource Provisioning Controller (604) is operatively coupled to the processor (601), the memory (602), and the communicator (603). The hardware implementation of the Cross-gNB Resource Provisioning Controller (604) enables efficient and reliable execution of processes associated with inter-gNB resource aggregation. The Cross-gNB Resource Provisioning Controller (604) receives a Resource Addition Request message, transmits a Resource Addition Request Acknowledge message, receives a message from the first node (500), coordinates with the UE (400) for activation or deactivation of an additional radio resource, coordinates with the first node (500), and performs or supports uplink synchronization of the additional radio resource.

In an embodiment, the Cross-gNB Resource Provisioning Controller (604) includes or is associated with control-state registers, buffer memories, timing circuits, synchronization circuits, radio resource control processing circuits, baseband processing circuits, inter-node interface circuits, transceiver control circuits, or dedicated logic circuits for supporting hardware-level execution of Resource Addition Request processing, Resource Addition Request Acknowledge generation, radio resource configuration, additional radio resource provisioning, activation or deactivation coordination, inter-node coordination, timing alignment, buffer management, uplink synchronization, and inter-gNB resource aggregation procedures.

In an embodiment, the Cross-gNB Resource Provisioning Controller (604), in cooperation with the processor (601), the memory (602), and the communicator (603), controls one or more hardware resources of the second node (600) to support inter-gNB resource aggregation. The one or more hardware resources include at least one baseband processor, radio transceiver, antenna module, timing circuit, synchronization circuit, buffer memory, control-state register, and inter-node communication interface. The Cross-gNB Resource Provisioning Controller (604) controls the one or more hardware resources based on the Resource Addition Request message, the Resource Addition Request Acknowledge message, and the message received from the first node (500), such that the second node (600) provisions the additional radio resource, coordinates activation or deactivation of the additional radio resource, and supports uplink synchronization with the UE (400).

In an embodiment, the Cross-gNB Resource Provisioning Controller (604) includes, or is associated with, one or more processing cores, accelerator circuits, control-state registers, buffer memories, comparator circuits, timing circuits, interface buses, memory controllers, or dedicated logic circuits that are configured to support hardware-level execution of structured orchestration package generation and validation, and execution mode selection.

In operation, the Cross-gNB Resource Provisioning Controller (604) receives a Resource Addition Request message from the first node (500) that requests configuration of at least one radio resource of the second node (600), and it transmits a Resource Addition Request Acknowledge message comprising the configuration information for at least one of the radio resources to the first node (500). Furthermore, the Cross-gNB Resource Provisioning Controller (604) receives a message from the first node (500) indicating one of addition and release of the at least one radio resource, coordinates with the first node (500) for one of activating and deactivating an additional radio resource, and coordinates with the UE (400) for an uplink synchronization of the additional radio resources.

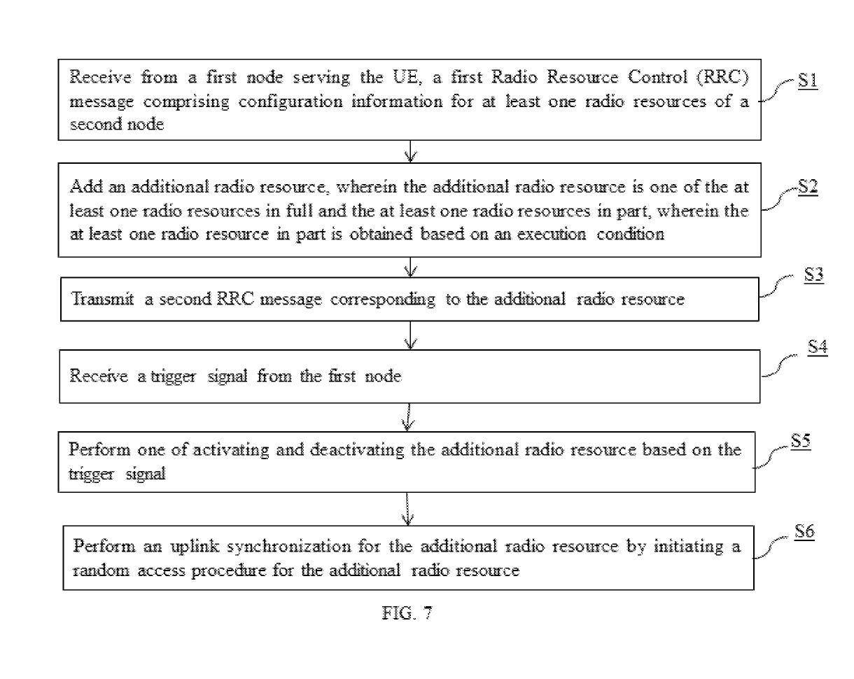

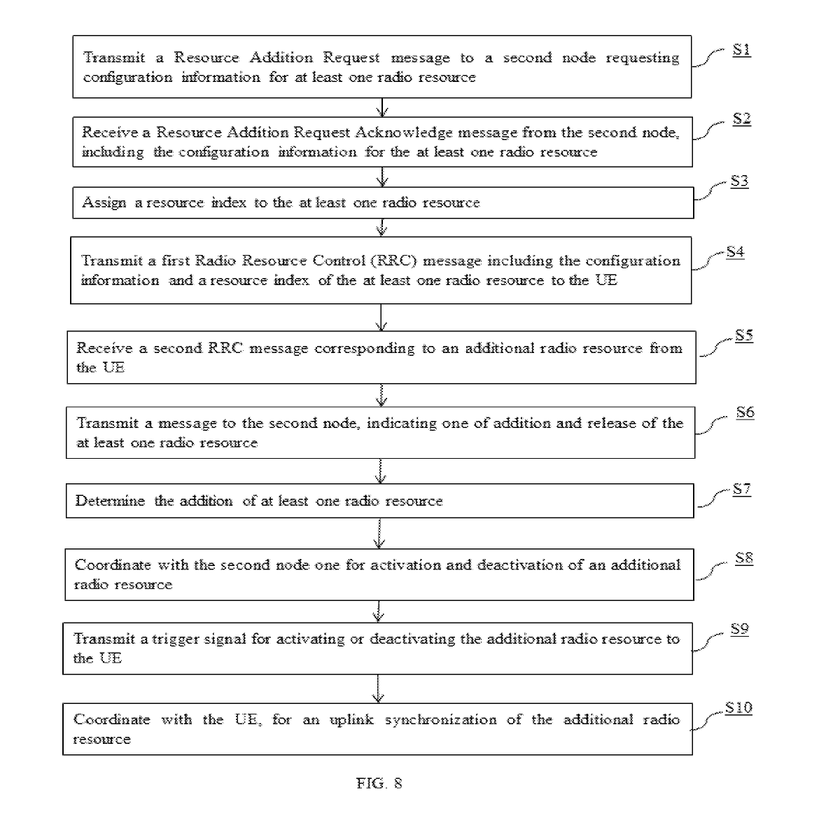

FIG. 7 is a flow diagram that illustrates a proposed method for inter-gNB resource aggregation by the UE (400) according to the embodiments disclosed herein. At step S1, the method includes receiving, by the UE (400) from a first node (500) serving the UE (400), a first RRC message comprising configuration information for at least one radio resource of a second node (600), where the at least one radio resource comprises at least one of at least one carrier, at least one band, and at least one transmission reception point. The configuration information for the at least one radio resource of the second node (600) further comprises at least one of a resource index assigned by the first node (500) and an execution condition to select at least one radio resource of the second node (600). The execution condition comprises at least one trigger condition based on a single reference signal type and at least one trigger quantity obtained using at least one of a reference signal received power (RSRP), a reference signal received quality (RSRQ), and a signal-to-interference-plus-noise ratio (SINR).

At step S2, the method further includes adding, by the UE (400), an additional radio resource, where the additional radio resource is one of the at least one radio resource in full and the at least one radio resource in part, and where the at least one radio resource in part is obtained based on an execution condition. At step S3, the method includes transmitting, by the UE (400), a second RRC message corresponding to the additional radio resource. The second RRC message comprises an acknowledgment to the additional radio resource of the second node (600).

In step S4, the method includes receiving, by the UE (400), a trigger signal from the first node (500). The trigger signal is received in one of the first RRC message and a MAC CE. The trigger signal received in RRC comprises one of a resourceState parameter in the first RRC message instructing the UE (400) to use the additional radio resource after receiving the RRC configuration for activation, and a resourceDeactivationTimer parameter to specify an inactivity period to deactivate the additional radio resource. Proceeding to step S5, the method includes performing, by the UE (400), one of activating and deactivating the additional radio resource based on the trigger signal. Here, activating the additional radio resource comprises initiating PDCCH monitoring for the additional radio resource after receipt of the MAC control element.

At step S6, the method includes performing, by the UE (400), an uplink synchronization for the additional radio resource by initiating a random access procedure for the additional radio resource. This step comprises transmitting, by the UE (400), a random access preamble in the additional radio resource, monitoring, by the UE (400), a random access response window, receiving, by the UE (400), a random access response comprising a timing advance value and an uplink grant, and applying, by the UE (400), the timing advance for transmission of information using the additional radio resource. The method for transmitting the random access preamble comprises receiving, by the UE (400), a PDCCH order from the second node (600) in the additional radio resource, receiving, by the UE (400), a PDCCH order from the first node (500), and receiving, by the UE (400), a ReconfigurationWithSync message including a RACH-ConfigDedicated structure in the first RRC message from the first node (500). The random access response is received from one of the first node (500) and the second node (600).

FIG. 8 is a flow diagram illustrating a proposed method for inter-gNB resource aggregation to serve the UE (400) by the first node (500) according to the embodiments disclosed herein. At step S1, the method includes transmitting, by the first node (500), a Resource Addition Request message to a second node (600) requesting configuration information for at least one radio resource. The Resource Addition Request message contains a Cell Radio Network Temporary Identifier (C-RNTI) of the UE (400). In addition, the Resource Addition Request message indicates at least one of: at least one radio resource is requested for conditional resource addition, and an upper limit on a number of radio resources to be prepared by the second node (600). At step S2, the method further includes receiving, by the first node (500), a Resource Addition Request Acknowledge message from the second node (600) including the configuration information for the at least one radio resource.

At step S3, the method includes assigning, by the first node (500), a resource index to the at least one radio resource. In step S4, the method includes transmitting, by the first node (500), a first Radio Resource Control (RRC) message including the configuration information and a resource index of the at least one radio resource to the UE (400). Proceeding to step S5, the method includes receiving, by the first node (500), a second RRC message corresponding to an additional radio resource from the UE (400). At step S6, the method includes transmitting, by the first node (500), a message to the second node (600) indicating one of addition and release of the at least one radio resource. At step S7, the method includes determining, by the first node (500), the addition of at least one radio resource.

In step S8, the method includes coordinating, by the first node (500), with the second node (600) for activation and deactivation of an additional radio resource. This step comprises transmitting, by the first node (500), direct activation of the additional radio resource in the Resource Addition Request message to the second node (600) and receiving, by the first node (500), a resourceState parameter and a resourceDeactivationTimer parameter in the Resource Addition Request Acknowledge message from the second node (600). Further, the method includes transmitting, by the first node (500), a request message for one of the activation and deactivation of the additional radio resource to the second node (600) and receiving, by the first node (500), a command message confirming one of the activation and deactivation of the additional radio resource from the second node (600). The resourceDeactivationTimer parameter is used to deactivate the additional radio resource after an inactivity period of the UE (400).

At step S9, the method includes transmitting, by the first node (500), a trigger signal for activating or deactivating the additional radio resource to the UE (400). At step S10, the method includes coordinating, by the first node (500), with the UE (400) for uplink synchronization of the additional radio resource. This step comprises receiving, by the first node (500), a random access response comprising a timing advance value and an uplink grant for the additional radio resource from the second node (600) and transmitting, by the first node (500), the random access response to the UE (400). Further, the method includes receiving, by the first node (500), contention-free random access resources from the second node (600) for the additional radio resource in the Resource Addition Request Acknowledge message and transmitting, by the first node (500), a PDCCH order to the UE (400) to identify the contention-free random access resources for the additional radio resource.

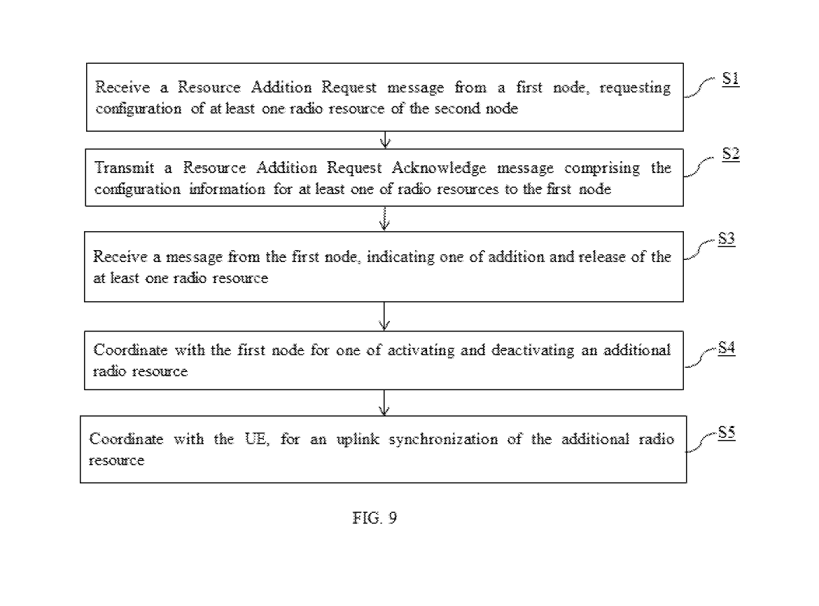

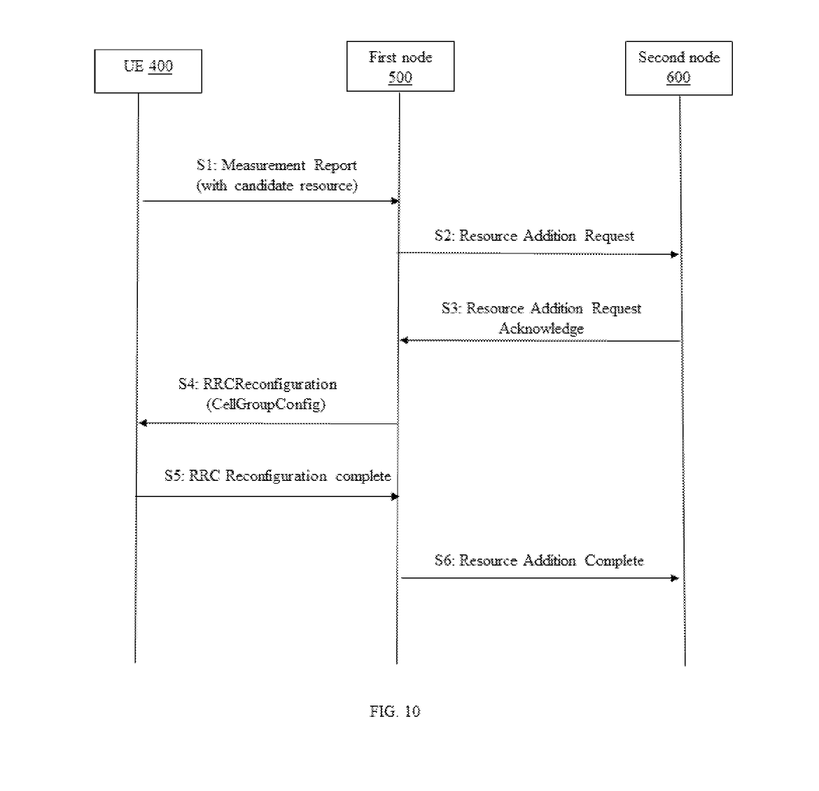

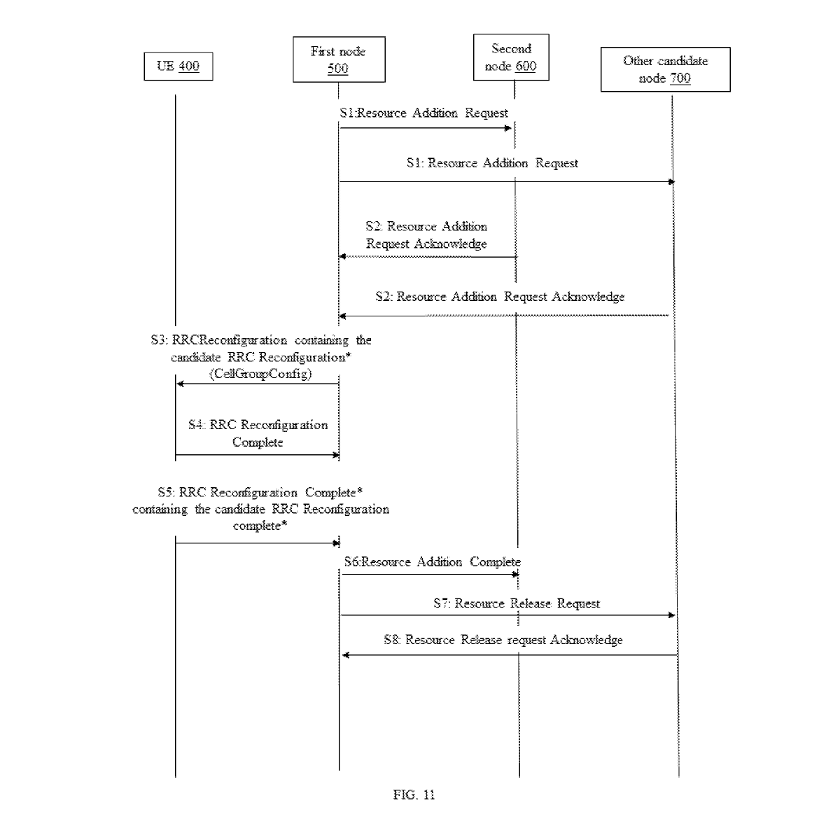

FIG. 9 is a flow diagram that illustrates a proposed method for inter-gNB resource aggregation to serve the UE (400) by the second node (600) according to the embodiments disclosed herein. At step S1, the method includes receiving, by the second node (600), a Resource Addition Request message from a first node (500), the Resource Addition Request message requesting configuration of at least one radio resource of the second node (600). At step S2, the method further includes transmitting, by the second node (600), a Resource Addition Request Acknowledge message comprising the configuration information for at least one of the radio resources to the first node (500). The Resource Addition Request Acknowledge message comprises at least one of a resourceState parameter, a resourceDeactivationTimer parameter, ReconfigurationWithSync, and tracking reference signal configuration for the at least one radio resource. At step S3, the method includes receiving, by the second node (600), a message from the first node (500) indicating one of an addition and a release of the at least one radio resource.

In step S4, the method includes coordinating, by the second node (600), with the first node (500) for one of activating and deactivating an additional radio resource. This step comprises receiving, by the second node (600), direct activation and deactivation of the additional radio resource in the Resource Addition Request message from the first node (500) and transmitting, by the second node (600), a resourceState parameter and a resourceDeactivationTimer parameter in the Resource Addition Request Acknowledge message to the first node (500). Furthermore, the method includes receiving, by the second node (600), a request message for one of the activation and deactivation of the additional radio resource from the first node (500) and transmitting, by the second node (600), a command message confirming one of the activation and deactivation of the additional radio resource to the first node (500).

Proceeding to step S5, the method includes coordinating, by the second node (600), with the UE (400) for an uplink synchronization of the additional radio resource. This step comprises transmitting, by the second node (600), a PDCCH order in the additional radio resource to the UE (400), receiving, by the second node (600), a random access preamble in the additional radio resource from the UE (400), and generating, by the second node (600), a random access response comprising a timing advance value and an uplink grant. Furthermore, the method includes transmitting, by the second node (600), a random access response comprising the timing advance value and the uplink grant for the additional radio resource for transmission to the first node (500) and transmitting, by the second node (600), the random access response on the additional radio resource to the UE (400).

The following embodiments disclose the proposed method of adding resources from a neighbouring gNB (gNB2) (second node) (600) to serve the UE (400) as an SCell to an existing CellGroup under a PCell, or as a TRP for the serving cell, or as an additional band for the serving cell under the gNB1 (first node) (500). This method can only be triggered through measurement-based addition, since the second node (600) is not co-located with the first node (500). In this process, the UE (400) first reports measurements of a candidate carrier or band to the first node (500) through a measurement report. After receiving these measurements from the UE (400), the first node (500) decides on adding the resource to serve the UE (400) and requests the configurations from the second node (600) using a handshake signal such as the Resource Addition Request message. Since there is no direct RRC connection between the UE (400) and the second node (600), the RRC entity of the first node (500) is responsible for adding the resource from the second node (600). In an embodiment for inter-gNB RA, the addition of a resource from another gNB can only be triggered based on UE measurements. This trigger can be initiated either by the gNB or by the UE.

FIG. 10 is a sequence diagram illustrating the signalling procedure for method P11 according to embodiments as disclosed herein. In an embodiment, in method P11 the serving gNB (first node (500)) initiates the resource addition by requesting carrier or band or TRP configurations from a neighbouring gNB (e.g., second node (600)). This request occurs after the UE (400) sends a measurement report that includes results for carriers or resources from the neighbouring gNB. A single measurement report can then be considered representative for a list of carriers or bands or TRPs even when operating with FR2 or FR3 frequency bands. The gNB then uses a Resource Addition Request message to begin the procedure of resource addition.

In an embodiment as depicted in FIG. 10, the trigger for resource addition is initiated by the serving gNB (first node (500)). To begin with, the first node (500) configures the UE (400) with the necessary measurement configuration to monitor carriers from a neighbouring gNB (second node (600)). Once this configuration is completed, the UE (400) starts measuring the specified carriers from the second node (600). When the configured event condition is met (e.g., a signal quality threshold is crossed), the UE (400) sends a measurement report back to the first node (500) at step S1. Based on the information in this measurement report, the first node (500) sends a Resource Addition Request to the second node (600) to obtain the configuration details of the target secondary cell or band or TRP at step S2. At step S3, the second node (600) responds with the required scellconfig/bandconfig/TRPConfig as part of a Resource Addition Request Acknowledge message. In scellconfig/bandconfig/TRPConfig, it assigns carrier IDs, configures Random Access (RA) for the cell, and sends the prepared scellconfig/bandconfig/TRPConfig to the first node (500) in the Resource Addition Request Acknowledge message.

In an embodiment, after receiving the configuration from the second node (600), the first node’s (500) RRC entity performs resource indexing with the configured SCells or the bands or the TRPs. Once the mapping is complete, the first node (500) prepares the scellconfig/bandconfig/TRPConfig including the assigned resourceindex and sends it to the UE (400) as part of an RRC Reconfiguration message at step S4. With this message, the addition of the secondary cell on the UE (400) side starts. At step S5, the UE (400) then responds with an RRC Reconfiguration Complete message to the first node (500), and at step S6 the first node (500) sends a Resource Addition Complete to the second node (600).

FIG. 11 is a sequence diagram illustrating a signalling procedure for method P12 according to embodiments disclosed herein. In an embodiment of method P12, the UE (400) does not send any measurement report to the first node (500). Instead, the necessary preconditions for resource addition based on measurements must already be configured by the first node (500). In this method, upon receiving a conditional resource addition (CRA) configuration, the UE (400) starts evaluating these conditions and stops once the resource (SCell/TRP/band) is successfully added. If a band with multiple carriers is conditionally configured, the UE (400) only needs to evaluate the execution conditions on any one of the carriers in the band. A single measurement can be considered as representative for a list of carriers or a band or a TRP. The UE (400) retains the CRA configuration unless the network explicitly indicates it to release it and continues evaluating execution conditions for new candidates from other gNBs.

In an embodiment as depicted in FIG. 11, the resource addition does not rely on the UE (400) sending a measurement report to the serving gNB (first node (500)). Rather, the process is proactively initiated by the first node (500), which configures the UE (400) with one or more CRA configurations. The resource addition is executed by the UE (400) itself based on the preconfigured CRA configuration provided by the first node (500). The entire process is initiated and coordinated by the first node (500) ahead of time, allowing the UE (400) to add the resource when the predefined execution conditions are satisfied, without any further signalling exchange for that specific addition.

In a CRA decision and resource request phase, the first node (500) decides to configure CRA for the UE (400). At step S1, it sends a Resource Addition Request to the neighbouring gNB (second node (600)), asking it to prepare cell configurations for one or more candidate cells. Additionally, the first node (500) also indicates that the request is for CRA, the upper limit on how many cells candidate gNBs should prepare for resource addition, and optionally the latest measurement results from the UE (400).

In a resource preparation phase by gNBs with candidate resources, if a candidate gNB admits the CRA request, it allocates necessary radio resources and prepares a list of candidate resources (SCells/TRPs). It assigns carrier IDs, configures Random Access for the carrier/TRP (if needed for synchronization during CRA execution), and sends back the prepared SCellConfig/TRPconfig/bandconfig to the first node (500) in a Resource Addition Request Acknowledge message at step S2.

In a CRA configuration delivery phase to the UE (400), upon receiving the configurations, the first node (500) assigns the resource index to the candidate resources. It maps each resource from a candidate gNB to a resourceIndex. At step S3, the first node (500) sends an RRC Reconfiguration message(s) corresponding to each gNB with the candidate resource to the UE (400). This message includes the CRA candidate resource configuration(s) received from gNBs with candidate resources, and the associated execution condition(s) for candidates are based on thresholds for RSRP, RSRQ, or SINR that the UE (400) must evaluate to satisfy the conditional event.

In a storage and acknowledgement phase, the UE (400) processes the RRC Reconfiguration message, stores the CRA configuration, and responds with an RRC Reconfiguration Complete message to the first node (500) at step S4.

In a condition evaluation phase by the UE (400), each CRA configuration includes one or more candidate resources (SCell/TRP). An execution condition may consist of one or two trigger condition(s) (based on RSRP and RSRQ, RSRP and SINR, etc.) as defined by a CondEvent. The definitions for conditional events could be some event to add the candidate resource based on UE (400) measurements. Only a single RS type and at most two different trigger quantities are used for the evaluation of a CRA execution condition of a single candidate resource. Each candidate resource can be configured with up to two trigger quantities based on RSRP and RSRQ.

The UE (400) begins evaluating the preconfigured execution conditions. If the condition for any candidate resource (SCell/TRP) is met (e.g., signal strength exceeds a threshold), the UE (400) proceeds to apply the relevant SCellConfig/TRPconfig/bandconfig and adds the corresponding carrier/band/TRP as an additional resource.

In a resource addition execution and CRA acknowledgement phase, upon executing the resource addition, the UE (400) sends the RRC Reconfiguration Complete message corresponding to the candidate resource to the first node (500) at step S5. This message also includes the identity of the selected candidate resource at the gNB and a corresponding RRC Reconfiguration Complete message for the gNB that has the candidate resource.

In response, the first node (500) sends a response to the selected candidate gNB. At step S6, the first node (500) sends a Resource Addition Complete message to the gNB of the selected candidate, confirming that the UE (400) has successfully completed the resource addition. Once the CRA procedure is executed successfully, the UE (400) releases all the other stored conditional reconfigurations for CRA.

At step S7, the first node (500) sends a conditional resource release request message(s) to cancel CRA in the other candidate gNBs, if configured, by sending a Resource Release Request message. Other candidate gNBs acknowledge the release request by sending a Resource Release Request Acknowledge message at step S8.

In a resource mapping phase at the first node (500), the first node (500) performs the resource mapping to the selected candidate resource. This ensures that the UE (400) remains unaware of the actual source gNB that provides the candidate resource, and the UE (400) simply sees it as a new resource assigned by the first node (500).

In an embodiment, before any CRA execution condition is satisfied, upon reception of a resource addition command, the UE (400) executes the resource addition procedure as described in the proposed method regardless of any previously received CRA configuration. Upon the successful completion of the resource addition procedure, the UE (400) releases the stored CRA configuration.

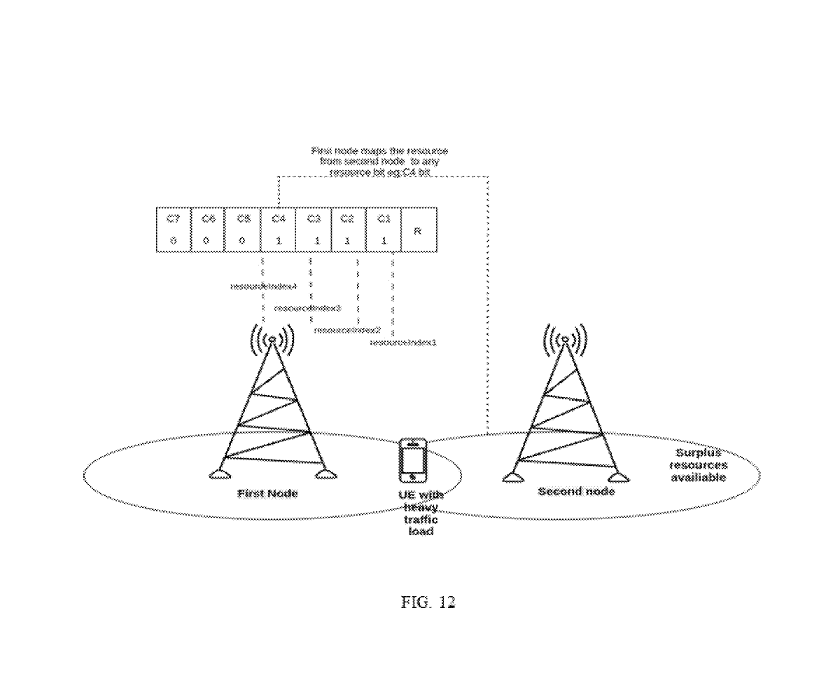

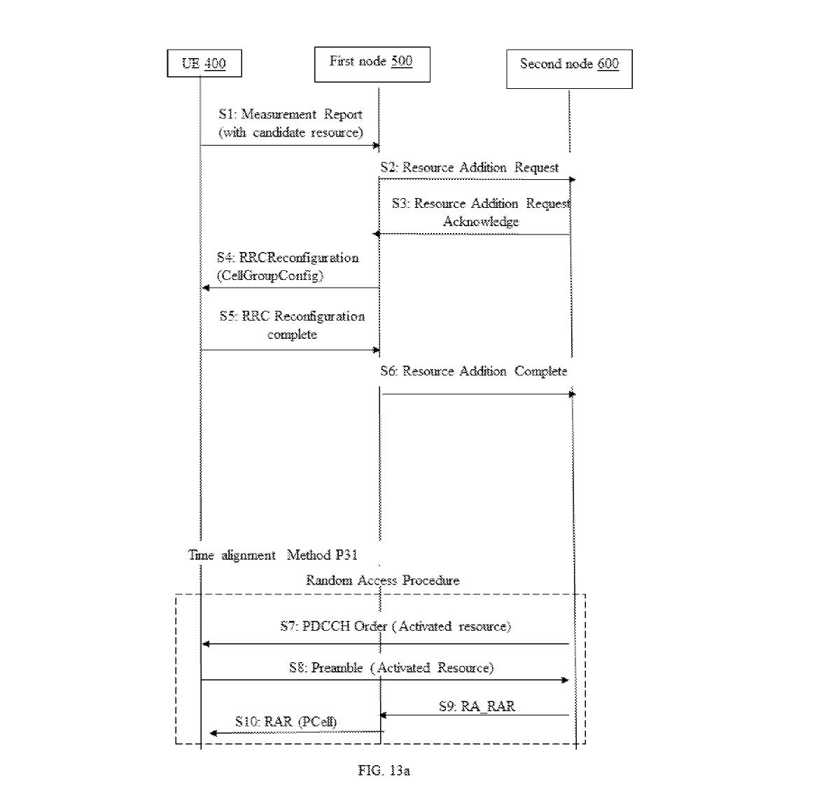

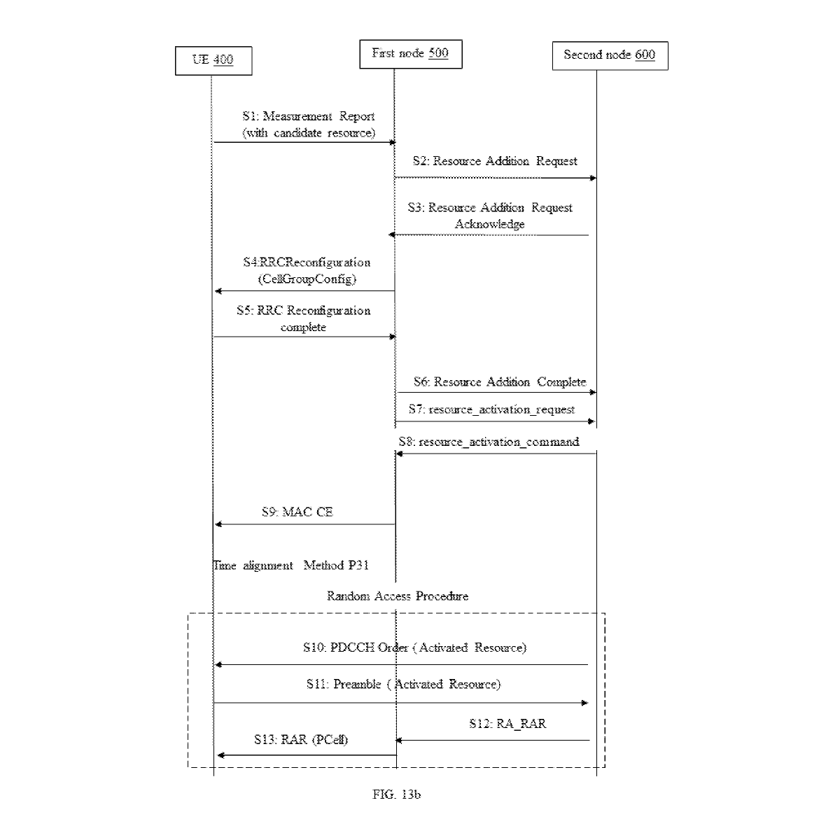

FIG. 12 is a schematic diagram illustrating the proposed resource mapping for inter-gNB coordination according to embodiments as disclosed herein.

In an embodiment, in the context of resource addition from a neighbouring gNB (second node (600)), resource mapping refers to the process of assigning a carrier or a band or a TRP configuration received from the neighbouring gNB (e.g., second node (600)) to a specific resourceIndex, which is one of SCellIndex, BandIndex, and TRPIndex values at the primary coordinating gNB (e.g., first node (500)). This mapping is essential in both the method P11 and the method P12. When the first node (500) requests resource configurations from the second node (600), it receives configuration parameters for the candidate carriers.

In an embodiment, the first node (500) then performs a carrier-to-resourceIndex mapping internally, as depicted in the figure, ensuring that the UE (400) receives the appropriate configuration in the RRC Reconfiguration message. In the case of a cell with multiple carriers as bands, a single configuration covering all carriers/bands in that cell is included in the RA Addition Request Acknowledge message. Thus, the UE (400) does not need to be aware of which gNB provided the carrier; it only sees a configuration indexed by resourceIndex. This unified view simplifies UE (400) behaviour during resource addition, activation, and deactivation and allows seamless coordination across multiple gNBs. Whether the resource is added immediately (as in the method P11) or conditionally (as in the method P12), this resource mapping is a mandatory step in inter-gNB RA, ensuring that all further operations on the resource are properly aligned with the internal configuration at the first node (500).

In an embodiment, for inter-gNB RA, the addition of a resource from another gNB can only be triggered based on the UE (400) measurements. This trigger can initiate either from the gNB or from the UE (400). In carrier aggregation, the UE (400) may be configured with a plurality of secondary Cells (SCells) in addition to the Primary Cell (PCell). However, not all SCells are always active. To efficiently manage resources and power consumption, the solution defines procedures for activating and deactivating resources (SCell/TRP/band) dynamically.

Further embodiments disclose the proposed method of activating the resources from a neighbouring gNB (second node (600)) to serve a UE (400) as a resource to an existing CellGroup under a PCell, or as a TRP for the serving cell, or as an additional band for the serving cell under the first node (500).

According to the current specification, SCell activation and deactivation procedures are applicable only when all carriers (including the PCell and SCells) are managed by the same gNB, since they are under the control of a single MAC entity. However, in scenarios where a resource is provided by a neighbouring gNB (e.g., second node (600)), as in the case of inter-gNB RA, multiple MAC entities are involved. Despite this, the UE (400) must continue to receive all Resource Activation/Deactivation MAC Control Elements (MAC CEs) only from the MAC entity of the first node (500). This requires coordination between the first node (500) and the second node (600), allowing the first node (500) to manage and send MAC CEs for signalling resources from the second node (600) to the UE (400), aligning with the 5G specification.

In an embodiment, the proposed enhancement introduces resource activation and deactivation through Layer 3 signalling, enabling coordination between the first node (500) and the second node (600). This approach becomes essential in inter-gNB coordination scenarios where the current single-MAC-based activation procedures are insufficient. To enable successful activation and deactivation of a resource for inter-gNB RA, additional coordination steps are required as provided below.

In an embodiment of resource indexing at the first node (500) (transparent to UE (400)), the first node (500) performs resource indexing by associating the carriers provided by the second node (600) with unused carrier bits at its own side. This ensures that the SCell/TRP/band configuration appears consistent and unified to the UE (400) without exposing the presence of resources from another gNB. This mapping step is crucial for maintaining MAC-layer transparency at the UE (400).

In an embodiment, a request for direct resource activation via RRC configuration is performed. As part of the RRC message exchange (e.g., Resource Addition Request), the first node (500) requests SCell configuration/TRP configuration/band configuration from the second node (600), explicitly asking for the resource to be activated upon configuration. This is done by adding the resourceState parameter in the resource configuration.

In response, the second node (600) responds with a resource configuration. The second node (600) acknowledges the request by providing the following parameters in the response (e.g., Resource Addition Request Acknowledge): the presence of resourceState in the resource configuration instructs the UE (400) to use the SCell/TRP/band immediately after the configuration, and ResourceDeactivationTimer specifies the duration of inactivity after which the SCell/TRP/band should be automatically deactivated by the UE (400). This ResourceDeactivationTimer applies to SCell/TRP/band configured from the second node (600).

In an embodiment of deactivation based on ResourceDeactivationTimer, once the UE (400) activates the resource, it also starts the configured ResourceDeactivationTimer. If no data activity is detected over the resource during this timer’s interval, the UE (400) automatically deactivates the resource. This eliminates the need for additional signalling to trigger deactivation and helps conserve radio resources.

In an embodiment, the proposed enhancement enables SCell/TRP/band activation and deactivation through Layer 2 signalling, leveraging both the standard MAC Control Element (MAC CE) and the Enhanced MAC CE formats for SCell activation/deactivation. The key enhancement here is the coordination between the first node (500) and the second node (600), allowing the first node (500) to retain control while triggering MAC-level actions related to SCell/TRP/bands located at the second node (600). This is essential in inter-gNB RA scenarios where different MAC entities are involved.

### Pre-Activation Configuration steps include:

Resource configuration from second node (600) to first node (500): As part of scellconfig/TRPconfig/bandconfig, the second node (600) provides the resource configuration to the first node (500), optionally including resourceDeactivationTimer parameters for timer-based deactivation and TRS configurations required to use for faster resource activation for enhanced MAC CE. Resource associated with the second node (600) will be activated/deactivated via the first node (500) to maintain UE (400) transparency.

Resource Indexing at first node (500) (Transparent to UE (400)): The first node (500) maps the resources from the second node (600) to its own unused carrier bits. If single resource is added from the second node (600), each bit (Ci) corresponds to the activation status of a specific resource indexed by resourceindex; a bit value of 1(0) indicates activation of the resource, and 0(1) indicates deactivation of the resource. This resource indexing ensures that the UE (400) perceives a seamless, single-gNB resource setup. This step ensures that the UE (400) is unaware that the resource originates from another gNB.

### Activation Procedure (Triggered by first node (500) using MAC CE) includes

### Option 1 using resource activation/deactivation MAC CE

Activation Request from first node (500) to second node (600): When the first node (500) determines that the resource provided by the second node (600) should be activated, it sends an activation request, resource activation request to the second node (600) using the interface responsible for coordination between the two gNBs. As per current 5G specifications, this coordination typically uses the F1AP and Xninterface.

Activation Command from second node (600) to first node (500): The second node (600) responds with an acknowledgment command, resource activation command confirming that the resource is ready for activation on its side using the Xn interface as per 5G specification.

MAC CE Transmission to UE (400) from first node (500): The first node (500) then sends the resource Activation/Deactivation MAC CE to the UE (400), where the required carrier bit (Ci) corresponding to the resource is set to '1(0)', indicating that the mapped resource is now active. The UE (400) then begins PDCCH monitoring.

### Option 2 using Enhanced resource activation/deactivation MAC CE

Activation Request with TRS from first node (500) to second node (600): When activation is needed, the first node (500) sends a request, resource activation request to the second node (600), explicitly requesting activation along with TRS information to enable fast synchronization by the UE (400).

Activation Command from second node (600) to first node (500): The second node (600) acknowledges the request and sends resource activation command to first node (500), confirming that the resource is ready for activation.

Enhanced MAC CE Sent to UE (400) by first node (500): The first node (500) then sends an Enhanced MAC CE to the UE (400), including: The carrier bits (Ci) with values set to ‘1(0)’ for activation and the TRS IDs, which the UE (400) uses for fast synchronization with the new resource. This allows the UE (400) to synchronize with the second node (600) with minimal delay.

Time alignment and uplink synchronization: If the SCells/TRPs are co-located with the PCell, the UE (400) applies the same timing advance as the PCell for the collocated SCells, since both the SCell and PCell will be in the same PTAG, which uses the same timing advance. A separate random access channel (RACH) procedure is required to achieve time alignment between the UE (400) and the newly added resource if it is in new TAG. This ensures proper uplink synchronization for data transmission.

The main challenge to achieve time alignment in inter-gNB RA is that it requires the coordination between gNBs, making CFRA resource allocation and context exchange challenging. This leads to increased signalling overhead and timing uncertainties due to the non-collocated nature of the SCell/TRP. Additionally, managing multiple timing sources from different gNBs need some improved time alignment mechanisms. CFRA resources for the resource are included in the resource configuration, to establish time alignment with the UE (400) for uplink transmission.

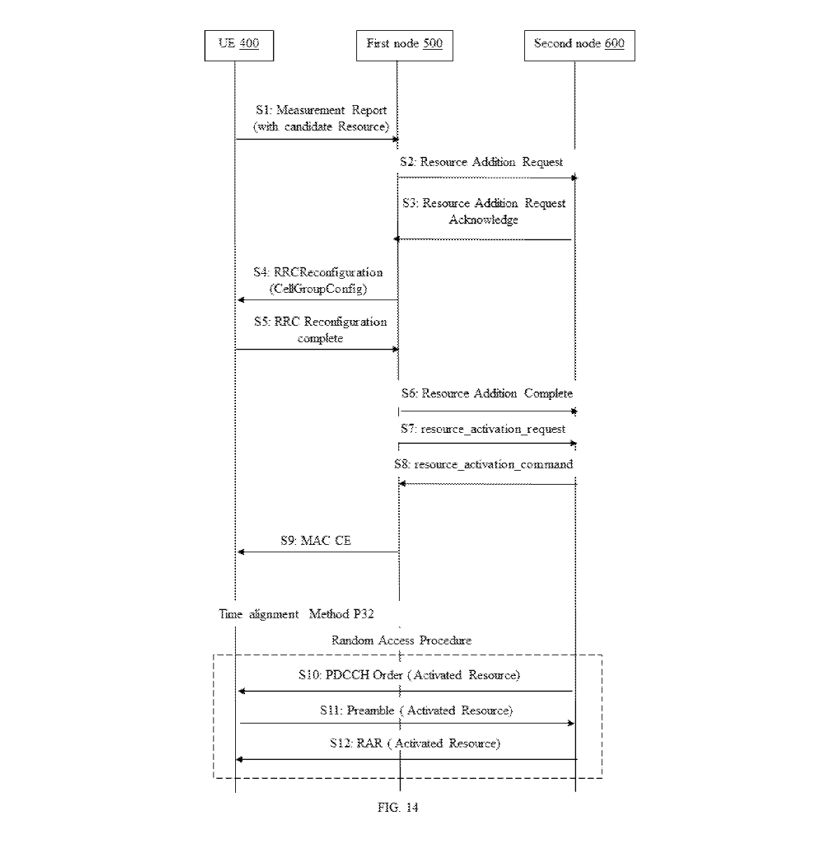

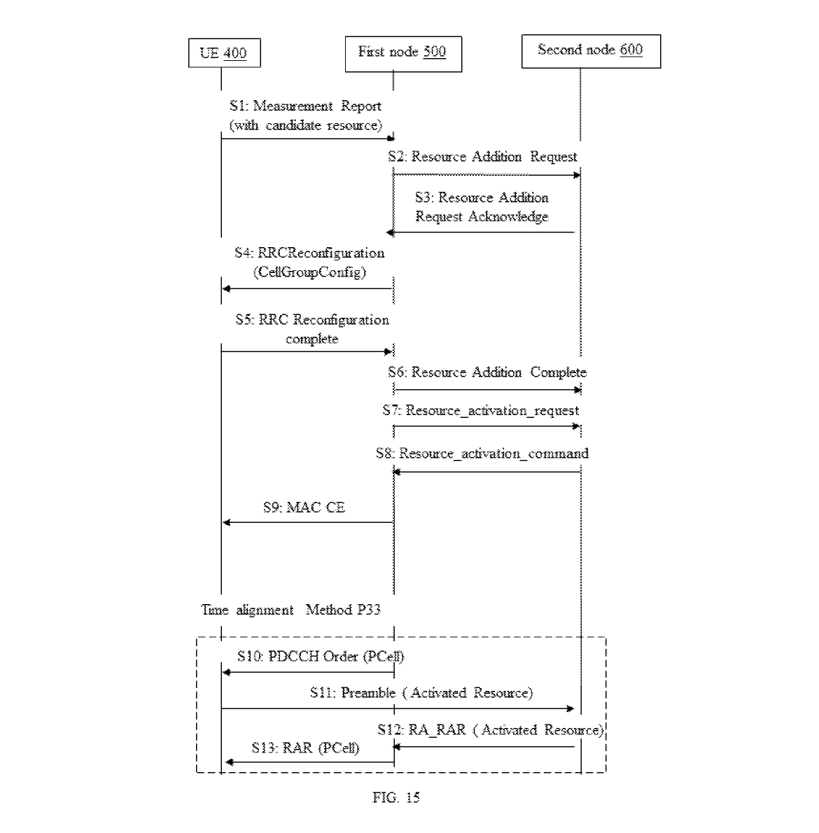

FIG. 13a is a sequence diagram illustrating the time alignment method P31 with RRC based activation and FIG. 13b is a sequence diagram illustrating the time alignment method P31 with MAC CE based activation according to embodiments as disclosed herein. In inter-gNB RA, where the PCell resides in the first node (500) and the Scell/TRP/band resides in the second node (600), the RAR is generated by the second node (600) and forwarded to the first node (500) over the Xn interface. The first node (500) then transmits the RAR to the UE (400), enabling uplink synchronization with the resource in the second node (600).

### Pre-configuration Requirements

To maintain transparency at the UE (400), the same UE (400) specific cell radio network temporary identifier (C-RNTI) must be used by second node (600). Therefore, first node (500) must share the UE’s (400) C-RNTI with second node (600) in the Resource Addition Request.

A valid random access response window, ra-ResponseWindow, must be configured so the UE (400) knows when and how long to wait for the RAR after sending msg1(preamble). This can be shared as part of RACH-ConfigCommon in scellconfig/TRPconfig/bandconfig in Resource Addition Request message

Time to trigger the PDCCH order: The RA process on the resource in a new TAG, can only begin after the resource is activated. Resource activation can happen through at least one of the following methods:

Option 1 – RRC Signalling based Activation: The first node (500) activates the resource by sending resourceState as part of RRC signalling to the UE (400). Once the second node (600) receives the resource Addition Complete message, it knows the resource is active and can proceed to initiate the RA procedure.

Option 2 – MAC Control Element (MAC CE) Activation: The second node (600) can trigger the RA procedure after sending the activation command to the first node (500) as response to the activation request from the first node (500).

RACH Procedure: After the resource of the second node (600) is activated by option 1 or option 2, the second node (600) initiates RA by sending a PDCCH Order on the resource. To achieve time alignment for band, any one carrier within the band must send a PDCCH order to the UE (400). To initiate RA using CFRA, the random access resources are indicated using the DCI information, i.e., within DCI Format 1_0 on the PDCCH when initiating a PDCCH order. If band added, the DCI can be transmitted on any one of the carriers within that band. The DCI provides the UE (400) with a PRACH preamble index along with a corresponding SS/PBCH block index to be used. This information is transmitted by DCI Format 1_0 with the PDCCH CRC scrambled by the assigned C-RNTI of the UE (400). The DCI Format 1_0 includes the following changes in the fields for the PDCCH order.

SS/PBCH index points to an SSB index for the resource used for PRACH mapping.

PRACH Mask Index: Determines the PRACH occasions corresponding to the SS/PBCH block index for the resource.

After getting the PDCCH order, the UE (400) transmits a msg1. The UE (400) transmits the msg1 as indicated in Step 1 on the activated resource of second node (600).

RAR Monitoring: After transmitting msg1, the UE (400) monitors for a RAR from the network within the configured RAR window. The UE (400) then monitors the PDCCH for a DCI Format 1_0 addressed to its RA-RNTI, which is derived from the PRACH configuration. This DCI grants the UE (400) resources to receive the RAR message. If the RAR timer expires before receiving a PDCCH transmission, the UE (400) retransmits the msg1.

RAR Generation and Forwarding: Upon receiving the msg1, the second node (600) TA and creates a MAC PDU containing the response from the second node (600) (RA_RAR). This message includes: timing advance value, uplink grant for future transmissions, the second node (600) forwards this RA_RAR to first node (500) via the Xn interface and RAR Delivery to UE (400): The first node (500) transmits the RAR that includes the timing advance to the UE (400) on PCell. Once the UE (400) receives the RAR, it applies the timing advance and completes synchronization with the resource in the second node (600).

As depicted in FIG. 13a, at step S1, the UE (400) sends a measurement report (with candidate resource) to the first node (500). At step S2,

the first node (500) then sends a Resource Addition Request message to the second node (600). The first node (500) here indicates the requested resource configuration information, including the complete UE (400) capabilities, the UE (400) capability coordination result, and the UE’s (400) CRNTI. In this case, it also provides the latest measurement results for the second node (600) to select and configure the resource in the second node (600). The first node (500) requests the resource to be in the activated state. At step S3, the second node (600) then responds with the Resource Addition Request Acknowledge to the first node (500). The second node (600) here selects the resources and provides the new resource radio resource configuration to the first node (500) within the second node (600) RRC configuration message, included in the Resource Addition Request Acknowledge message. If the first node (500) requested the resource to be activated, the second node (600) may keep the resource activated. If resource radio resources have been requested, the resource radio resource configuration is provided. At step S4, the first node (500) sends a RRCReconfiguration (CellGroupConfig) to the UE (400). Here, the indexing of resource in the second node (600) to resource in the first node (500) is decided by the first node (500) and is passed to the UE (400) resourceconfig as part of cell group config. At step S5, the UE (400) responds with a RRC Reconfiguration complete message to the first node (500). At step S6, the first node (500) sends a Resource Addition Complete message to the second node (600). The random access procedure includes at step S7, the second node (600) sends a PDCCH Order (Activated resource) to the UE (400). Based on the UE (400) measurement report sent by the first node (500) to the second node (600), the second node (600) identifies the strongest SSB beam in the resource for the UE (400). The second node (600) will then send the dedicated Random Access Preamble Index, PRACH Mask Index, and the strongest SSB Index, addressed in the DCI_1_0 bits scrambled with the UE’s (400) C-RNTI. At step S8, the UE (400) then responds with a Preamble (Activated Resource) to the second node (600) and then the second node (600) sends a RA_RAR to the first node (500) at step S9. Here, the MAC entity in second node (600) calculates the TA for the UE (400) and sends the TA command to first node (500) through the Xn-U interface. At step S10, the first node

(500) sends a RAR (PCell) to the UE (400). The first node (500) here sends the TA command received from the second node (600) to the UE (400) using the PCell.

Further, as depicted in FIG. 13b, at step S1, the UE (400) sends a measurement report (with candidate resource) to the first node (500). At step S2, the first node (500) then sends a Resource Addition Request message to the second node (600). Here, the first node (500) indicates the requested resource configuration information, including the complete UE (400) capabilities, the UE (400) capability coordination result, and the UE’s (400) CRNTI. In this case, it also provides the latest measurement results for the second node (600) to select and configure the resource in the second node (600). At step S3, the second node (600) then responds with the Resource Addition Request Acknowledge to the first node (500). Here, the second node (600) selects the resources and provides the new resource radio resource configuration to the first node (500) within a second node (600) RRC configuration message, included in the resource Addition Request Acknowledge message. If the first node (500) requested the resource to be activated, the second node (600) may keep the resource activated. At step S4, the first node (500) sends a RRCReconfiguration (CellGroupConfig) to the UE (400). Here, indexing of resource in the second node (600) to resource in the first node (500) is decided by the first node (500) and is passed to the UE (400) resourceconfig as part of cell group config. At step S5, the UE (400) responds with a RRC Reconfiguration complete message to the first node (500). At step S6, the first node (500) sends a Resource Addition Complete message to the second node (600). At step S7, the first node (500) further sends a resource_activation_request to the second node (600). The MAC entity in the first node (500) requests for the activation of resource using Xn-U interface. At step S8, the second node (600) responds with a resource_activation_command to the first node (500). The MAC entity in the second node (600) decides the activation of resource and the command is send to the first node (500) using Xn-U interface. At step S9, the First node (500) sends the MAC CE to the UE (400) for the activation of the resource belonging to second node (600). The random access procedure includes at step S10, the second node (600) sends a PDCCH Order (Activated resource) to the UE (400). Based on the UE (400) measurement report sent by the first node (500) to the second node (600), the second node (600) identifies the strongest SSB beam in the resource for the UE (400). The second node (600) will then send the dedicated Random Access Preamble Index, PRACH Mask Index, and the strongest SSB Index, addressed in the DCI_1_0 bits scrambled with the UE’s (400) C-RNTI. At step S11, the UE (400) then responds with a Preamble (Activated Resource) to the second node (600) and then the second node (600) sends a RA_RAR to the first node (500) at step S12. The MAC entity in the second node (600) calculates the TA for the UE (400) and sends the TA command to the first node (500) through the Xn-U interface. At step S13, the first node (500) sends a RAR (PCell) to the UE (400). The first node (500) sends the TA command received from the second node (600) to the UE (400) using the PCell.

FIG. 14 is a sequence diagram illustrating a time alignment method P32 with MAC CE-based activation according to embodiments disclosed herein. The method follows the same RA procedure flow as disclosed in method P31, with the only key difference being that the RAR is not routed through the PCell via the Xn interface; instead, it is transmitted directly from the SCell/TRP/band (second node (600)) to the UE (400).

In a first aspect, resource activation and PDCCH order are performed as follows. Once the resource in the second node (600) is activated (using either RRC signalling or MAC CE as explained in method P31), the second node (600) sends a PDCCH order on the resource. As disclosed in method P31, the PDCCH order uses DCI Format 1_0 scrambled with the UE’s (400) C-RNTI and provides the UE (400) with the necessary configuration, including a dedicated preamble index and PRACH resources.

In a second aspect, msg1 transmission is performed such that the UE (400) transmits msg1 using the assigned PRACH configuration on the activated resource.

In a third aspect, RAR transmission from the resource is performed such that, after receiving msg1, the second node (600) calculates the TA and prepares a MAC PDU with the RAR. This RAR is sent directly on the resource to the UE (400).

In a fourth aspect, RAR reception and completion are performed as follows. The UE (400) monitors for a PDCCH addressed to its RA-RNTI. Upon decoding, the UE (400) extracts the MAC PDU and verifies the RAPID to confirm that the response is for its preamble. Upon finding a valid RAPID match, the UE (400) accepts the TA and uplink grant, thereby completing the RA procedure.

Although direct RAR transmission from the resource simplifies signalling and reduces latency, it is not supported in 5G specifications.

As depicted in FIG. 14, at step S1 the UE (400) sends a measurement report (with candidate resource) to the first node (500). At step S2, the first node (500) then sends a Resource Addition Request message to the second node (600). Here, the first node (500) indicates the requested resource configuration information, including the complete UE (400) capabilities, the UE (400) capability coordination result, and the UE (400) C-RNTI. In this case, the first node (500) also provides the latest measurement results for the second node (600) to select and configure the resource in the second node (600).

At step S3, the second node (600) responds with a Resource Addition Request Acknowledge to the first node (500). Here, the second node (600) selects the resources and provides the new resource radio resource configuration to the first node (500) within a second node (600) RRC configuration message included in the Resource Addition Request Acknowledge message. If the first node (500) requested the resource to be activated, the second node (600) may keep the resource activated.

At step S4, the first node (500) sends an RRCReconfiguration (CellGroupConfig) to the UE (400). Indexing of the resource in the second node (600) to the resource in the first node (500) is decided by the first node (500) and is passed to the UE (400) resourceconfig as part of the cell group config. At step S5, the UE (400) responds with an RRC Reconfiguration Complete message to the first node (500).

At step S6, the first node (500) sends a Resource Addition Complete message to the second node (600). At step S7, the first node (500) further sends a resource_activation_request to the second node (600). The MAC entity in the first node (500) requests the activation of the resource using the Xn-U interface. At step S8, the second node (600) responds with a resource_activation_command to the first node (500). Here, the MAC entity in the second node (600) decides the activation of the resource and the command is sent to the first node (500) using the Xn-U interface.

At step S9, the first node (500) sends the MAC CE to the UE (400) for the activation of the resources. The random access procedure includes, at step S10, that the second node (600) sends a PDCCH order (activated resource) to the UE (400). Based on the UE (400) measurement report sent by the first node (500) to the second node (600), the second node (600) identifies the strongest SSB beam in the resource for the UE (400). The second node (600) then sends the dedicated Random Access Preamble Index, PRACH Mask Index, and the strongest SSB Index addressed in the DCI_1_0 bits scrambled with the UE’s (400) C-RNTI.

At step S11, the UE (400) responds with a preamble (activated resource) to the second node (600), and then the second node (600) sends an RAR (activated resource) directly to the UE (400) at step S12. Here, the MAC entity in the second node (600) calculates the TA for the UE (400) and sends the TA command to the UE (400) on the activated resource.

FIG. 15 is a sequence diagram illustrating a time alignment method P33 with MAC CE based activation according to embodiments as disclosed herein. In an embodiment, the method is different from the method P31 and the method P32 by initiating the PDCCH order on a PCell (first node (500)), whereas in the previous methods the PDCCH order is initiated on the resource (second node (600)). Accordingly, to send the PDCCH order by the first node (500), CFRA resources are initially communicated to the first node (500) by the second node (600) as part of a Resource Addition Request Acknowledge.

### Preconfiguration Requirements

To maintain transparency at the UE (400), the same C-RNTI must be used by the second node (600). Therefore, the first node (500) must share the UE’s (400) C-RNTI with the second node (600) in the Resource Addition Request.

To initiate the PDCCH order by the first node (500) as part of the Resource Addition Request Acknowledge, the CFRA resources such as SSB index, PRACH occasion, and preamble as part of RACH-ConfigDedicated are mentioned as part of scellconfig/TRPconfig/bandconfig sent by the second node (600). This procedure is similar to L1/L2 triggered mobility (LTM), where the PDCCH order can come through the serving cell based on the initial LTM candidate configurations given by the LTM candidate cells. The CFRA resources indicated in the RACH-ConfigDedicated can then be used to design the DCI Format 1_0 on the PDCCH by the first node (500) when initiating a PDCCH order.

A valid random access response window ra-ResponseWindow must be configured so the UE (400) knows when and how long to wait for the RAR after sending msg1. This can be shared as part of RACH-ConfigCommon in scellconfig/TRPconfig/bandconfig in a Resource Addition Acknowledge message.

### Time to trigger the PDCCH order

The RA process on the resource can only begin after the resource is activated. Resource activation can happen through at least one of the following methods.

Option 1: RRC Signalling based Activation. The first node (500) activates the resource by sending resourceState as a part of the RRC signalling to the UE (400). Once the first node (500) gets the RRC Configuration Complete message, it knows the resource is active and can proceed to initiate the RA procedure.

Option 2: MAC CE based Activation. The first node (500) triggers the RA procedure after it sends the activation/deactivation MAC CE to the UE (400).

### RACH Procedure

After the resource of the second node (600) is activated by Option 1 or Option 2, the first node (500) initiates RA by sending a PDCCH order on the PCell. To initiate RA using CFRA, the random access resources are indicated using the DCI information, i.e., within DCI Format 1_0 on the PDCCH when initiating a PDCCH order. The DCI provides the UE (400) with a PRACH preamble index along with a corresponding SS/PBCH block index. This information is transmitted by DCI Format 1_0 with the PDCCH CRC scrambled by the assigned C-RNTI of the UE (400).

msg1 Transmission: The UE (400) transmits msg1 using the assigned PRACH configuration on the activated resource.

RAR Monitoring: After transmitting the msg1, the UE (400) monitors for a response (RAR) from the network within the configured RAR window. The UE (400) then monitors the PDCCH for a DCI Format 1_0 addressed to its RA-RNTI, which is derived from the PRACH configuration. This DCI grants the UE (400) resources to receive the RAR message. If the RAR timer expires before receiving a PDCCH transmission, the UE (400) retransmits msg1.

RAR Generation and Forwarding: Upon receiving the msg1, the second node (600) calculates the Timing Advance and creates a MAC PDU including the response (RA_RAR). This message includes a Timing Advance value and an Uplink grant for future transmissions. The second node (600) forwards this RA_RAR to the first node (500) via the Xn interface.

RAR Delivery to UE (400): The first node (500) transmits the RAR to the UE (400) on the PCell. Once the UE (400) receives the RAR, it applies the Timing Advance and completes synchronization with the resource in the second node (600).

As depicted in FIG. 15, at step S1 the UE (400) sends a measurement report (with candidate resource) to the first node (500). At step S2 the first node (500) then sends a Resource Addition Request message to the second node (600). Here, the first node (500) indicates the requested resource configuration information including the complete UE (400) capabilities, the UE (400) capability coordination result, and the UE’s (400) C-RNTI. In this case, it also provides the latest measurement results for the second node (600) to select and configure the resource in the second node (600). At step S3 the second node (600) then responds with the Resource Addition Request Acknowledge to the first node (500). Here, the second node (600) selects the resource and provides the new resource radio resource configuration to the first node (500) within the second node (600) RRC configuration message included in the CA/TRP Addition Request Acknowledge message. If the first node (500) requested the resource to be activated, the second node (600) may keep the resource activated. CFRA resources for the strongest SSB beams (based on the measurement report) are passed in a RACH-ConfigDedicated parameter to allocate the dedicated PRACH resources to the UE (400). At step S4 the first node (500) sends an RRCReconfiguration (CellGroupConfig) to the UE (400). Indexing of the resource in the second node (600) to the resource in the first node (500) is decided by the first node (500) and is passed to the UE (400) resourceconfig as part of the cell group config. At step S5 the UE (400) responds with an RRC Reconfiguration Complete message to the first node (500). At step S6 the first node (500) sends a Resource Addition Complete message to the second node (600), and at step S7 the first node (500) further sends a resource_activation_request to the second node (600). The MAC entity in the first node (500) requests the activation of the resource using the Xn-U interface. At step S8 the second node (600) responds with a resource_activation_command to the first node (500). The MAC entity in the second node (600) decides the activation of the resource and the command is sent to the first node (500) using the Xn-U interface. At step S9 the first node (500) sends the MAC CE to the UE (400) for the activation of the resource belonging to the second node (600).

The random access procedure includes, at step S10, that the first node (500) sends a PDCCH order (PCell) to the UE (400). The first node (500) then sends the dedicated Random Access Preamble Index, PRACH Mask Index, and the strongest SSB Index provided as a part of RACH-configdedicated addressed in the DCI_1_0 bits scrambled with the UE’s (400) C-RNTI. At step S11 the UE (400) responds with a Preamble (Activated Resource) to the second node (600). Here, the UE (400) sends the preamble on the activated resource. The second node (600) sends an RA_RAR (Activated Resource) to the first node (500) at step S12. The MAC entity in the second node (600) calculates the TA for the UE (400) and sends the TA command to the first node (500) through the Xn-U interface. At step S13 the first node (500) sends an RAR (PCell) to the UE (400). Here, the first node (500) sends the TA command received from the second node (600) to the UE (400) using the PCell.

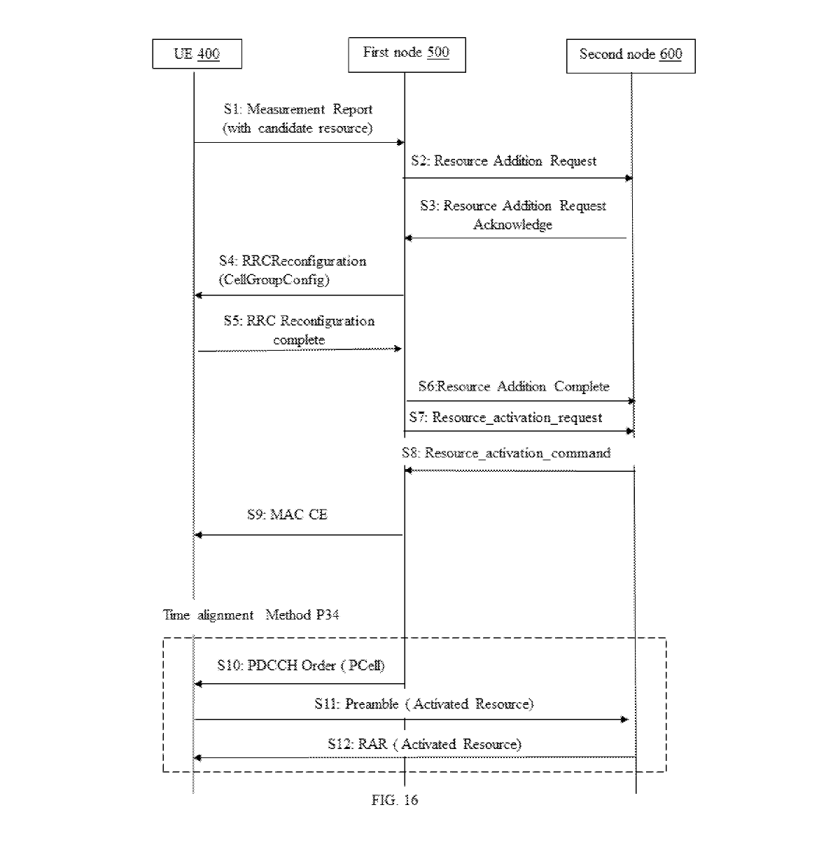

FIG. 16 is a sequence diagram illustrating a time alignment method P34 with MAC CE-based activation according to embodiments as disclosed herein. In an embodiment, the method is similar to the method P33, with the key difference being the entity responsible for delivering the RAR. While the method P33 routes the RAR through the PCell (first node (500)), in the method P34 the RAR is transmitted directly from the resource (second node (600)) to the UE (400). This eliminates the need for RAR forwarding over the Xn interface, thereby reducing signalling latency and complexity. All other steps remain the same as in the method P33, including the preconfiguration requirements (such as sharing of the C-RNTI, CFRA resource provisioning via RACH-ConfigDedicated in the Resource Addition Request, and RAR window configuration), the timing to trigger the PDCCH order, msg1 transmission on the activated resource by the UE (400) using the assigned PRACH configuration, RAR monitoring by the UE (400) within the configured window, and RAR generation by the second node (600), where it calculates the Timing Advance and creates a MAC PDU containing the Random Access Response. The only variation lies in the RAR delivery step; instead of forwarding the RAR to the first node (500) for transmission over the PCell, the second node (600) directly sends the RAR to the UE (400) over the activated resource. This optimization allows for faster uplink synchronization and reduces inter-node signalling overhead.

As depicted in FIG. 16, at step S1 the UE (400) sends a measurement report (with candidate resource) to the first node (500). At step S2 the first node (500) then sends a Resource Addition Request message to the second node (600). In this step, the first node (500) indicates the requested resource configuration information, including the complete UE (400) capabilities, the UE (400) capability coordination result, and the UE’s (400) C-RNTI. In this case, it also provides the latest measurement results for the second node (600) to select and configure the resources in the second node (600). At step S3 the second node (600) then responds with the Resource Addition Request Acknowledge to the first node (500). Here, the second node (600) selects the resources and provides the new resource radio resource configuration to the first node (500) within a second node (600) RRC configuration message included in the Resource Addition Request Acknowledge message. If the first node (500) requested the resource to be activated, the second node (600) may keep the resource activated. CFRA resources for the strongest SSB beams (based on the measurement report) are passed in the RACH-ConfigDedicated parameter to allocate the dedicated PRACH resources to the UE (400).

At step S4 the first node (500) sends an RRCReconfiguration (CellGroupConfig) to the UE (400). Indexing of the resource in the second node (600) to the resource in the first node (500) is decided by the first node (500) and is passed to the UE (400) resourceconfig as part of the cell group config. At step S5 the UE (400) responds with an RRC Reconfiguration Complete message to the first node (500). At step S6 the first node (500) sends a Resource Addition Complete message to the second node (600), and at step S7 the first node (500) further sends a resource_activation_request to the second node (600). The MAC entity in the first node (500) requests the activation of the resource using the Xn-U interface. At step S8 the second node (600) responds with a resource_activation_command to the first node (500). The MAC entity in the second node (600) decides the activation of the resource and the command is sent to the first node (500) using the Xn-U interface. At step S9 the first node (500) sends the MAC CE to the UE (400) for the activation of the resource.

The random access procedure includes, at step S10, that the first node (500) sends a PDCCH Order (PCell) to the UE (400). The first node (500) then sends the dedicated Random Access Preamble Index, PRACH Mask Index, and the strongest SSB Index provided as a part of RACH-ConfigDedicated, addressed in the DCI_1_0 bits scrambled with the UE (400)’s C-RNTI. At step S11 the UE (400) responds with a Preamble (Activated Resource) to the second node (600). In this step, the UE (400) sends the preamble on the activated resource. At step S12 the second node (600) sends a RAR (Activated Resource) directly to the UE (400). Here, the MAC entity in the second node (600) calculates the TA for the UE (400) and sends the TA command to the UE (400) on the activated resource.

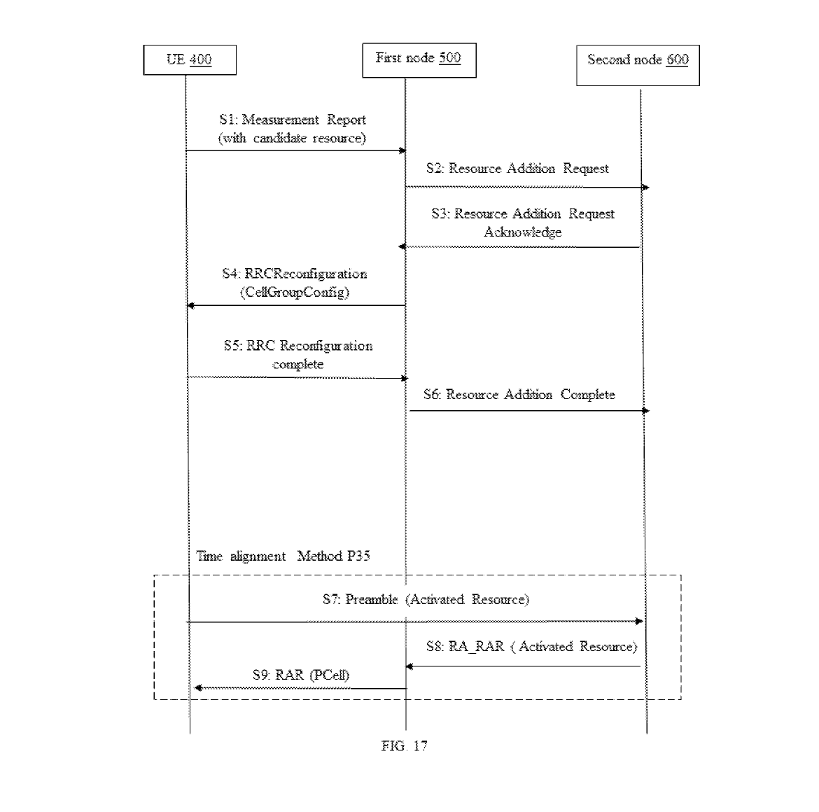

FIG. 17 is a sequence diagram illustrating the time alignment method P35 with RRC-based activation according to embodiments as disclosed herein. Although ReconfigurationWithSync and dedicated RRC signalling are currently specified only for PSCell addition, the concept is extended here to the resource for inter gNB coordination. Instead of using a PDCCH order to deliver CFRA resources, as is standard for the SCell procedure for time alignment, this method assumes the delivery of RACH-ConfigDedicated to the UE (400) through dedicated RRC signaling. The configuration is provided within a ReconfigurationWithSync message as part of the SCellConfig/TRPconfig/bandconfig. Once the UE (400) receives this configuration, it begins transmitting the dedicated preamble to the resource. RACH-ConfigDedicated provides the UE (400) with detailed random access parameters, enabling it to perform the procedure. The gNB may include this configuration in an RRCReconfiguration message, allowing the UE (400) to complete random access with the resource without relying on system information. The second node (600) allocates dedicated preambles for each SSB beam.

With respect to preconfiguration requirements, the second node (600) prepares the RACH-ConfigDedicated structure to allocate CFRA resources for the UE (400). During the initial Resource Addition Request Acknowledge, the second node (600) sends this information to the first node (500), and the first node (500) sends these as a part of the SCellConfig/TRPconfig/bandconfig to the UE (400) as an RRC reconfiguration message. Within this, the ReconfigurationWithSync element provides the RACH-ConfigDedicated that defines when and where the UE (400) should perform random access.

RACH-ConfigDedicated specifies the resources to perform the random access procedure. It includes a resources section, which assigns dedicated PRACH preambles to the UE (400). These preambles are beam-specific, allowing the second node (600) to allocate a unique preamble for each SS/PBCH Block.

Furthermore, the embedded RACH-ConfigGeneric parameters define time-frequency resources, power control settings, and the RAR window. These parameters allow the UE (400) to map PRACH opportunities to the corresponding SSB beams. The CFRA-SSB-Resource list includes ra-PreambleIndex (the index used for the dedicated preamble) and the SSB ID used by the UE (400) for beam selection.

Time to initiate random access on the resource is constrained such that the RA process on the resource can only begin after the resource is activated. The resource activation can happen through at least one of the following methods.

In an RRC signalling-based activation (required for this method), the resource is activated via RRC signalling. The first node (500) activates the resource by sending resourceState as part of the RRC signalling to the UE (400). The SCell/TRP/band configuration, including RACH-ConfigDedicated, is provided to the UE (400) within a ReconfigurationWithSync message during the RRCReconfiguration procedure. Upon receiving this message, the UE (400) performs the reconfiguration and typically initiates the RA procedure immediately. Therefore, to ensure correct timing and avoid premature RA initiation, RRC signalling-based activation must be used to make sure the resource is already active when the UE (400) initiates CFRA.

MAC CE-based activation is not applicable to do the time alignment because the UE (400) is expected to start the RA procedure immediately after receiving ReconfigurationWithSync. In a MAC CE-based activation scenario, the UE (400) would not have a reliable mechanism to determine when the resource is active and ready for RA, leading to potential synchronization failure.

The RACH procedure includes the following. For msg1 transmission, the UE (400) transmits the dedicated preamble corresponding to the strongest SS/PBCH Block beam available on the activated resource (second node (600)) according to the details given in the RACH-ConfigDedicated. For RAR monitoring, after transmitting msg1, the UE (400) monitors for a response (RAR) from the network within the configured RAR window. The UE (400) then monitors the PDCCH for a DCI Format 1_0 addressed to its RA-RNTI, which is derived from the PRACH configuration. This DCI grants the UE (400) resources to receive the RAR message. If the RAR timer expires before receiving a PDCCH transmission, the UE (400) retransmits msg1.

For RAR generation and forwarding, upon receiving msg1, the second node (600) calculates the Timing Advance and creates a MAC PDU containing the response (RA_RAR) that includes the TA value. For RAR delivery to the UE (400), the first node (500) transmits the RAR to the UE (400) on the PCell. Once the UE (400) receives the RAR, it applies the timing advance and completes synchronization with the resource in the second node (600).

As depicted in FIG. 17, at step S1 the UE (400) sends a measurement report (with candidate resource) to the first node (500). At step S2 the first node (500) then sends a Resource Addition Request message to the second node (600). Here, the first node (500) indicates the requested resource configuration information, including the complete UE (400) capabilities, the UE (400) capability coordination result, and the UE’s (400) CRNTI. In this case, it also provides the latest measurement results for the second node (600) to select and configure the resource in the second node (600), and the first node (500) requests the resource to be in the activated state. At step S3 the second node (600) then responds with the Resource Addition Request Acknowledge to the first node (500). Here, the second node (600) selects the resources and provides the new resource radio resource configuration to the first node (500) within a second node (600) RRC configuration message included in the Resource Addition Request Acknowledge message. If the first node (500) requested the resource to be activated, the second node (600) may keep the resource activated. CFRA resources are passed in the RACH-ConfigDedicated parameter in ReconfigurationWithSync to allocate the dedicated PRACH resources to the UE (400). At step S4 the first node (500) sends an RRCReconfiguration (CellGroupConfig) to the UE (400). Indexing of the resource in the second node (600) to the resource in the first node (500) is decided by the first node (500) and is passed to the UE (400) in resourceconfig as part of CellGroupConfig. At step S5 the UE (400) responds with an RRC Reconfiguration Complete message to the first node (500). At step S6 the first node (500) sends a Resource Addition Complete message to the second node (600).

The random access procedure further includes, at step S7, that the UE (400) sends a preamble (Activated Resource) to the second node (600). Here, the UE (400) performs synchronisation towards the resource indicated in the RRCConnectionReconfiguration message. The UE (400) sends the preamble on the activated resource when it receives the ReconfigurationWithSync. The second node (600) sends an RA_RAR (Activated Resource) to the first node (500) at step S8. At step S9 the first node (500) then transmits a RAR (PCell) to the UE (400). Here, the first node (500) sends the TA command received from the second node (600) to the UE (400) using the PCell.

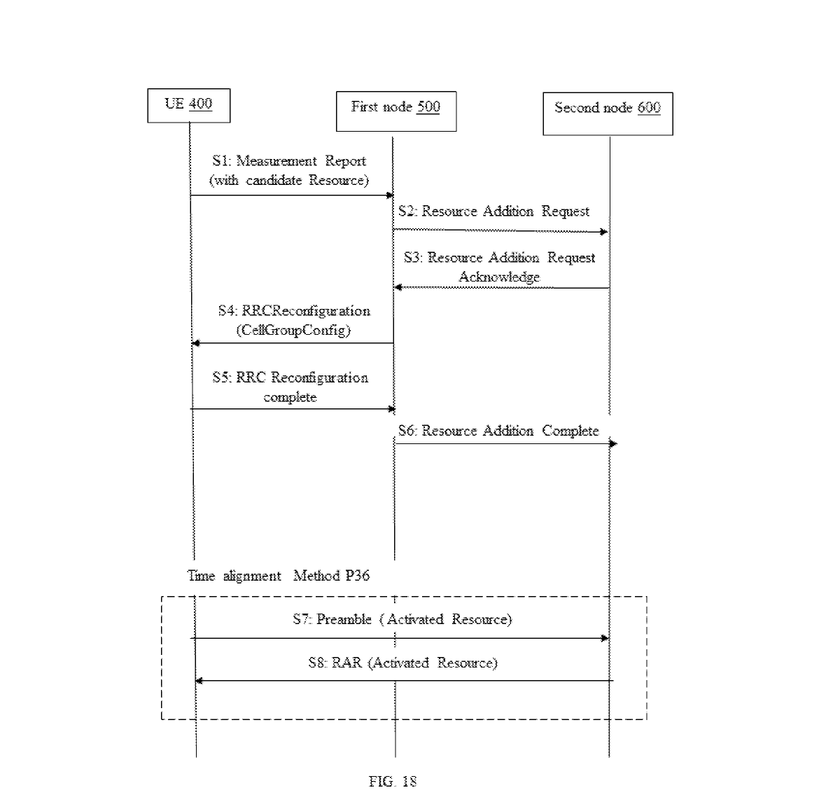

FIG. 18 is a sequence diagram illustrating a time alignment method P36 with RRC-based activation according to embodiments as disclosed herein. The method follows the same procedure as method P35, including the preconfiguration via ReconfigurationWithSync, RACH-ConfigDedicated delivery, resource activation through RRC signaling, and the complete RACH procedure (msg1 transmission, RAR monitoring, etc.). The only difference lies in the RAR delivery step. Instead of forwarding the RAR to the first node (500) for transmission via the PCell, the second node (600) directly transmits the RAR to the UE (400) over the activated resource. This avoids Xn signalling latency and enables faster synchronization with the resource.

As depicted in FIG. 18, at step S1 the UE (400) sends a measurement report (with candidate resource) to the first node (500). At step S2 the first node (500) then sends a Resource Addition Request message to the second node (600). In this step the first node (500) indicates the requested resource configuration information, including the complete UE (400) capabilities, the UE (400) capability coordination result, and the UE’s (400) CRNTI. In this case it also provides the latest measurement results for the second node (600) to select and configure the resource in the second node (600). The first node (500) requests the resource to be in the activated state. At step S3 the second node (600) then responds with the Resource Addition Request Acknowledge to the first node (500). In this step the second node (600) selects the resources and provides the new resource radio resource configuration to the first node (500) within a second node (600) RRC configuration message contained in the Resource Addition Request Acknowledge message. If the first node (500) requested the resource to be activated, the second node (600) may keep the resource activated. CFRA resources are passed in the RACH-ConfigDedicated parameter in ReconfigurationWithSync to allocate the dedicated PRACH resources to the UE (400). At step S4 the first node (500) sends an RRCReconfiguration (CellGroupConfig) to the UE (400). Indexing of the resource in the second node (600) to the resource in the first node (500) is decided by the first node (500) and is passed to the UE (400) resourceconfig as part of the cell group config. At step S5 the UE (400) responds with an RRC Reconfiguration Complete message to the first node (500). At step S6 the first node (500) sends a Resource Addition Complete message to the second node (600). The random access procedure includes, at step S7, that the UE (400) sends a Preamble (Activated Resource) to the second node (600). In this step the UE (400) performs synchronisation towards the resource indicated in the RRCConnectionReconfiguration message. The UE (400) sends the preamble on the activated resource when it receives the ReconfigurationWithSync. At step S8 the second node (600) sends a RAR (Activated Resource) directly to the UE (400). The MAC entity in the second node (600) calculates the TA for the UE (400) and sends the TA command to the UE (400) on the activated resource.

In an embodiment, inter-gNB resource aggregation is an effective approach for utilizing surplus radio resources from neighbouring cells, especially when traffic load is unevenly distributed across adjacent gNBs. Unlike Dual Connectivity, which relies on the Xn interface to transfer RLC SDUs between gNBs, resulting in additional latency, inter-gNB RA enables data to be either duplicated or split directly from the core network without the need for Xn-based data forwarding. This proposal focuses on enhancing current SCell addition, activation, and time alignment procedures in carrier aggregation to enable the inter-gNB resource aggregation. This allows the UE to experience the aggregated carriers as a single cell group even when using FR1/FR2 carriers from different gNBs, with minimal signalling overhead and/or complexity compared to the Dual Connectivity.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We is claimed is:

1. A method performed by a user equipment (UE) (400) for inter-gNB resource aggregation, the method comprising:
receiving, by the UE (400), from a first node (500) serving the UE (400), a first Radio Resource Control (RRC) message comprising configuration information for at least one radio resources of a second node (600), wherein the at least one radio resources comprise at least one of at least one carrier, at least one band, and at least one transmission reception point;
adding, by the UE (400), an additional radio resource, wherein the additional radio resource is one of the at least one radio resources in full and the at least one radio resources in part, wherein the at least one radio resource in part is obtained based on an execution condition;
transmitting, by the UE (400), a second RRC message corresponding to the additional radio resource;
receiving, by the UE (400), a trigger signal, from the first node (500);
performing, by the UE (400), one of activating and deactivating the additional radio resource based on the trigger signal;
performing, by the UE (400), an uplink synchronization for the additional radio resource by initiating a random access procedure for the additional radio resource.

2. The method as claimed in claim 1, wherein the configuration information for at least one radio resources of the second node (600) further comprises at least one of a resource index assigned by the first node (500) and an execution condition to select at least one radio resource of the second node (600).

3. The method as claimed in claim 1, wherein the execution condition comprises at least one trigger condition based on a single reference signal type and at least one trigger quantity obtained using at least one of a reference signal received power (RSRP), a reference signal received quality (RSRQ), and a signal-to-interference-plus-noise ratio (SINR).

4. The method as claimed in claim 1, wherein the second RRC message comprises acknowledgment to the additional radio resource of the second node (600).

5. The method as claimed in claim 1, wherein the trigger signal is received in one of first RRC message and MAC CE.

6. The method as claimed in claim 5, wherein the trigger signal received in RRC comprises one of a resourceState parameter in the first RRC message instructing the UE (400) to use the additional radio resource after receiving the RRC configuration for activation, and a resourceDeactivationTimer parameter to specify an inactivity period to deactivate the additional radio resource.

7. The method as claimed in claim 1, wherein activating the additional radio resources comprises initiating PDCCH monitoring for the additional radio resources after receipt of the MAC control element.

8. The method as claimed in claim 1, wherein performing uplink synchronization comprises:
transmitting, by the UE (400), a random access preamble in the additional radio resource;
monitoring, by the UE (400) a random access response window;
receiving, by the UE (400), a random access response comprising a timing advance value and an uplink grant; and
applying, by the UE (400), the timing advance for transmission of information using the additional radio resource.

9. The method as claimed in claim 8, wherein transmitting the random access preamble further comprises one of:
receiving, by the UE (400), a PDCCH order from the second node (600) in the additional radio resources;
receiving, by the UE (400), a PDCCH order from the first node (500);
receiving, by the UE (400), a ReconfigurationWithSync message including a RACH-ConfigDedicated structure in the first RRC message from the first node (500).

10. The method as claimed in claim 8, wherein the random access response is received from one of the first node (500) and the second node (600).

11. A method performed by a first node (500) for inter-gNB resource aggregation to serve a user equipment (UE) (400), the method comprising:
transmitting, by a first node (500), a Resource Addition Request message to a second node (600) requesting configuration information for at least one radio resource;
receiving, by the first node (500), a Resource Addition Request Acknowledge message from the second node (600), including the configuration information for the at least one radio resource;
assigning, by the first node (500), a resource index to the at least one radio resource;
transmitting, by the first node (500), a first Radio Resource Control (RRC) message including the configuration information and a resource index of the at least one radio resource to the UE (400);
receiving, by the first node (500), a second RRC message corresponding to an additional radio resource from the UE (400);
transmitting, by the first node (500), a message to the second node (600), indicating one of addition and release of the at least one radio resource;
determining, by the first node (500), the addition of at least one radio resource;
coordinating, by the first node (500), with the second node (600) one for activation and deactivation of an additional radio resource;
transmitting, by the first node (500), a trigger signal for activating or deactivating the additional radio resource to the UE (400); and
coordinating, by the first node (500), with the UE (400), for an uplink synchronization of the additional radio resource.

12. The method as claimed in claim 11, wherein the Resource Addition Request message contains Cell Radio Network Temporary Identifier (C-RNTI) of the UE (400).

13. The method as claimed in claim 11, wherein the Resource Addition Request message indicates at least one of at least one radio resource is requested for conditional resource addition and an upper limit on a number of radio resources to be prepared by the second node (600).

14. The method as claimed in claim 11, wherein coordinating for one of activating and deactivating comprises:
transmitting by the first node (500), direct activation of the additional radio resource, in the Resource Addition Request message to the second node (600); and
receiving by the first node (500), a resourceState parameter and a resourceDeactivationTimer parameter, in the Resource Addition Request Acknowledge message, from the second node (600).

15. The method as claimed in claim 11, wherein coordinating for one of activating and deactivating comprises:
transmitting, by the first node (500), a request message for the one of the activation and deactivation of the additional radio resource to the second node (600); and
receiving, by the first node (500), a command message confirming one of the activation and deactivation of the additional radio resource from the second node (600).

16. The method as claimed in claim 14, wherein the resourceDeactivationTimer parameter is used to deactivate the additional radio resource after an inactivity period of the UE (400).

17. The method as claimed in claim 11, wherein coordinating with the UE (400) for uplink synchronization further comprises:
receiving by the first node (500), a random access response comprising a timing advance value and an uplink grant for the additional radio resource from the second node (600); and
transmitting by the first node (500), the random access response to the UE (400).

18. The method as claimed in claim 11, wherein coordinating with the UE (400) uplink synchronization further comprises:
receiving by the first node (500), contention-free random access resources from the second node (600) for the additional radio resource in the Resource Addition Request Acknowledge message; and
transmitting by the first node (500), a PDCCH order to the UE (400) to identify the contention-free random access resources for the additional radio resource.

19. A method performed by a second node (600) for inter-gNB resource aggregation to serve a user equipment (UE) (400), the method comprising:
receiving, by a second node (600), a Resource Addition Request message from a first node (500), requesting configuration of at least one radio resource of the second node (600);
transmitting, by the second node (600), a Resource Addition Request Acknowledge message comprising the configuration information for at least one of radio resources to the first node (500);
receiving, by the second node (600), a message from the first node (500), indicating one of addition and release of the at least one radio resource;
coordinating, by the second node (600), with the first node (500) for one of activating and deactivating an additional radio resource; and
coordinating, by the second node (600), with the UE (400), for an uplink synchronization of the additional radio resource.

20. The method as claimed in claim 19, wherein the Resource Addition Request Acknowledge message comprises at least one of a resourceState parameter, a resourceDeactivationTimer parameter, ReconfigurationWithSync and tracking reference signal configuration for the at least one radio resource.

21. The method as claimed in claim 19, wherein coordinating one of the activating and deactivating comprises:
receiving by the second node (600), direct activation and deactivation of the additional radio resource in the Resource Addition Request message from the first node (500); and
transmitting, by the second node (600), a resourceState parameter and a resourceDeactivationTimer parameter in the Resource Addition Request Acknowledge message to the first node (500).

22. The method as claimed in claim 19, wherein coordinating one of the activating or deactivating of the additional radio resource comprises:
receiving, by the second node (600), a request message for the one of the activation and deactivation of the additional radio resource from the first node (500); and
transmitting, by the second node (600), a command message confirming one of the activation and deactivation of the additional radio resource to the first node (500).

23. The method as claimed in claim 19, wherein coordinating with the UE (400) for uplink synchronization further comprising:
transmitting, by the second node (600), a PDCCH order, in the additional radio resource, to the UE (400);
receiving, by the second node (600), the random access preamble in the additional radio resource from the UE (400); and
generating, by the second node (600), the random access response comprising a timing advance value and an uplink grant.

24. The method as claimed in claim 19, wherein coordinating with the UE (400) for uplink synchronization further comprises one of:
transmitting, by the second node (600), a random access response comprising a timing advance value and an uplink grant for the additional radio resource for transmission to the first node (500); and
transmitting, by the second node (600), the random access response on the additional radio resource to the UE (400).

25. A user equipment (UE) (400) for inter-gNB resource aggregation, comprising:
a memory (402);
a processor (401); and
a Cross-gNB Resource Aggregation Controller (404) coupled to the memory (402) and the processor (401), wherein the Cross-gNB Resource Aggregation Controller (404):
receives from a first node (500) serving the UE (400), a first Radio Resource Control (RRC) message comprising configuration information for at least one radio resources of a second node (600), wherein the at least one radio resources comprise at least one of at least one carrier, at least one band, and at least one transmission reception point;
adds an additional radio resource, wherein the additional radio resource is one of the at least one radio resources in full and the at least one radio resources in part, wherein the at least one radio resource in part is obtained based on an execution condition;
transmits a second RRC message corresponding to the additional radio resource;
receives a trigger signal, from the first node (500);
performs one of activating and deactivating the additional radio resource based on the trigger signal; and
performs an uplink synchronization for the additional radio resource by initiating a random access procedure for the additional radio resource.

26. A first node (500) for inter-gNB resource aggregation, comprising:
a memory (502);
a processor (501); and
a Cross-gNB Resource Orchestration Controller (504) coupled to the memory (502) and the processor (501), wherein the Cross-gNB Resource Orchestration Controller (504):
transmits a Resource Addition Request message to a second node (600) requesting configuration information for at least one radio resource;
receives a Resource Addition Request Acknowledge message from the second node (600), including the configuration information for the at least one radio resource;
assigns a resource index to the at least one radio resource;
transmits a first RRC message including the configuration information and a resource index of the at least one radio resource to the UE (400);
receives a second RRC message corresponding to an additional radio resource from the UE (400);
transmits a message to the second node (600), indicating one of addition and release of the at least one radio resource;
determines the addition of at least one radio resource;
coordinates with the second node (600) one for activation and deactivation of an additional radio resource;
transmits a trigger signal for activating or deactivating the additional radio resource to the UE (400); and
coordinates with the UE (400), for an uplink synchronization of the additional radio resource.

27. A second node (600) for inter-gNB resource aggregation, comprising:
a memory (602);
a processor (601); and
a Cross-gNB Resource Provisioning Controller (604) coupled to the memory (602) and the processor (601), wherein the Cross-gNB Resource Provisioning Controller (604):
receives a Resource Addition Request message from a first node (500), requesting configuration of at least one radio resource of the second node (600);
transmits a Resource Addition Request Acknowledge message comprising the configuration information for at least one of radio resources to the first node (500);
receives a message from the first node (500), indicating one of addition and release of the at least one radio resource;
coordinates with the first node (500) for one of activating and deactivating an additional radio resource; and
coordinates with the UE (400), for an uplink synchronization of the additional radio resource.
